(19) United States
(12) Patent Application Publication
(10) Pub. No.: US 2022/0309443 A1
(43) Pub. Date: Sep. 29, 2022

(54) PACKAGE MANAGEMENT SYSTEM, PACKAGE MANAGEMENT METHOD, AND PROGRAM-STORING STORAGE MEDIUM

(71) Applicants: NEC Corporation, Minato-ku, Tokyo (JP); NEC Platforms, Ltd., Kawasaki-shi, Kanagawa (JP)

(72) Inventors: Jun UCHIMURA, Tokyo (JP); Furnihiko SUGIURA, Tokyo (JP); Shingo SUZUKI, Kanagawa (JP); Yasuyuki YAMAKAWA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 17/615,886

(22) PCT Filed: Jun. 4, 2020
(86) PCT No.: PCT/JP2020/022103

§ 371 Date: Dec. 2, 2021

(30) Foreign Application Priority Data
Jun. 5, 2019 (JP) 2019-105320

(51) Int. Cl. G06Q 10/08; B65G 1/137

(52) U.S. Cl. CPC G06Q 10/087; B65G 1/137; G06Q 30/06

(57) ABSTRACT

A package management system provided with a storeroom for stowing multiple packages; and a window apparatus comprising receiving means for receiving one or more packages to be received and stowing the one or more packages in the storeroom, and discharging means for discharging, from the storeroom, one or more packages to be discharged.

### TECHNICAL FIELD

The present invention pertains to a package management system, a package management method, and a program-storing storage medium.

### BACKGROUND ART

Convenience store employees perform many types of work aside from selling food and daily necessities, including putting out and arranging merchandise, ordering merchandise, preparing beverages and food, managing electronic equipment such as copiers, and receiving packages to be delivered. Technologies relating to the management of packages as in the present disclosure are included in Patent Document 1 and Patent Document 2.

Patent Document 1 discloses technology relating to an automatic luggage checking apparatus. Additionally, Patent Document 2 discloses technologies for sorting aircraft luggage by destination and flight, and for temporarily stowing aircraft luggage in a storeroom.

### CITATION LIST

### Patent Literature

### [Patent Document 1]

Japanese Unexamined Patent Application, First Publication No. 2003-223658

### [Patent Document 2]

Japanese Unexamined Patent Application, First Publication No. 2001-240218

### SUMMARY OF THE INVENTION

### Problems to be Solved by the Invention

For businesses in which there is package receiving work for packages, such as in convenience stores as mentioned above, technologies for reducing the labor required for the package receiving work are desired.

Therefore, an example of an object of the present invention is to provide a package management system, a package management method, and a program that can solve the above-mentioned problem.

### Means for Solving the Problems

In a first aspect of the present disclosure, a package management system is provided with a storeroom for stowing multiple packages; and a window apparatus comprising receiving means for receiving one or more packages to be received and stowing the one or more packages in the storeroom, and discharging means for discharging, from the storeroom, one or more packages to be discharged.

In a second aspect of the present disclosure, a package management method in a package management system provided with a storeroom for stowing multiple packages includes receiving one or more packages to be received and stowing the one or more packages in the storeroom; and discharging, from the storeroom, one or more packages to be discharged.

In a third aspect of the present disclosure, a program stored in a storage medium makes a computer of a window apparatus in a package management system provided with a storeroom for stowing multiple packages perform processes of receiving one or more packages to be received and stowing the one or more packages in the storeroom; and discharging, from the storeroom, one or more packages to be discharged.

### Advantageous Effects of Invention

According to the present invention, in businesses in which there is package receiving work for packages, the labor required for the package receiving work can be reduced.

### BRIEF DESCRIPTION OF THE DRAWINGS

FIG. 1 is a diagram illustrating a package management system according to the present embodiment.

FIG. 2 is a diagram illustrating a summary of processing in a window apparatus according to the present embodiment.

FIG. 3 is a diagram illustrating an installation example for the window apparatus according to the present embodiment.

FIG. 4 is a diagram illustrating details of a package management system according to the present embodiment.

FIG. 5 is a diagram illustrating a schematic structure of a window apparatus according to the present embodiment.

FIG. 6 is a diagram illustrating a hardware structure of a window control apparatus according to the present embodiment.

FIG. 7 is an overall perspective view of a window apparatus according to the present embodiment.

FIG. 8 is an overall perspective view of a window apparatus according to the present embodiment.

FIG. 9 is a schematic diagram illustrating conveyance of a package in the window apparatus according to the present embodiment.

FIG. 10 is a section view illustrating a structure of a placement part in the window apparatus according to the present embodiment.

FIG. 11 is a schematic diagram illustrating a structure of a dimensional measurement apparatus according to the present embodiment.

FIG. 12 is a schematic diagram illustrating a structure of a first light projector according to the present embodiment.

FIG. 13 is a functional block diagram of a window control apparatus according to the present embodiment.

FIG. 14 is a first diagram illustrating a processing flow of the window apparatus according to the present embodiment.

FIG. 15 is an example of a table used to compute delivery fees according to the present embodiment.

FIG. 16 is a diagram illustrating another structural example of the package management system according to the present embodiment.

FIG. 17 is a functional block diagram of a storeroom control apparatus according to the present embodiment.

FIG. 18 is a diagram illustrating a pre-registration screen according to the present embodiment.

FIG. 19 is a diagram illustrating a registration complete screen according to the present embodiment.

FIG. 20 is a second diagram illustrating a processing flow of the window apparatus according to the present embodiment.

FIG. 21 is a third diagram illustrating a processing flow of the window apparatus according to the present embodiment.

FIG. 22 is a first diagram illustrating a processing flow of the storeroom control apparatus.

FIG. 23 is a second diagram illustrating a processing flow of the storeroom control apparatus.

FIG. 24 is a third diagram illustrating a processing flow of the storeroom control apparatus.

FIG. 25 is a fourth diagram illustrating a processing flow of the storeroom control apparatus.

FIG. 26 is a fifth diagram illustrating a processing flow of the storeroom control apparatus.

FIG. 27 is a sixth diagram illustrating a processing flow of the storeroom control apparatus.

FIG. 28 is a seventh diagram illustrating a processing flow of the storeroom control apparatus.

FIG. 29 is an eighth diagram illustrating a processing flow of the storeroom control apparatus.

FIG. 30 is a diagram illustrating the minimum structure of the window apparatus.

FIG. 31 is a diagram illustrating the processing flow according to the minimum-structure window apparatus.

### EXAMPLE EMBODIMENT

Hereinafter, a package management system according to an embodiment of the present invention will be explained with reference to the drawings.

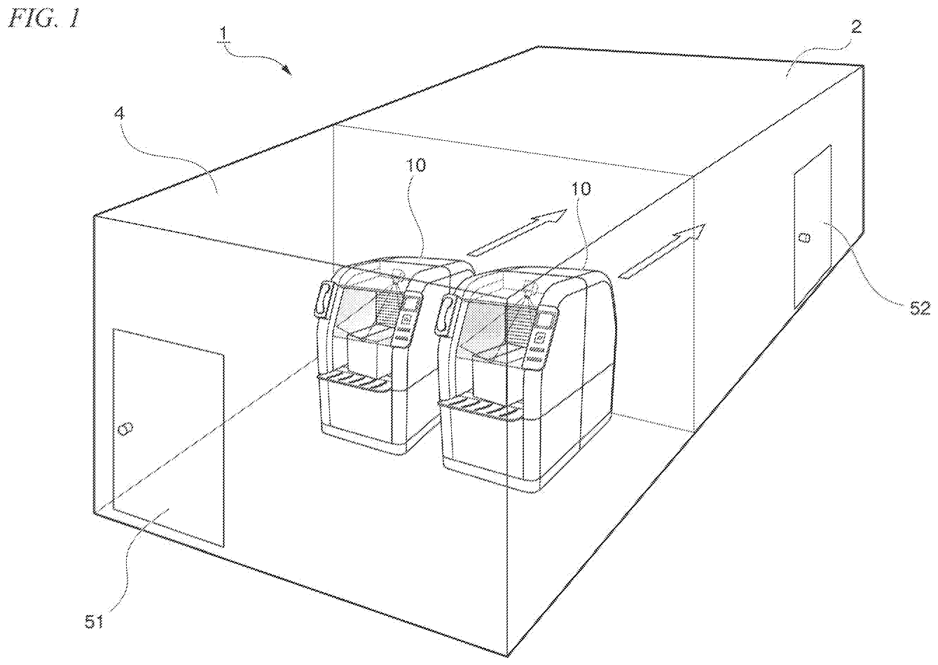

FIG. 1 is a diagram illustrating a package management system according to the present embodiment.

The package management system 1 is provided with a window apparatus 10 and a storeroom 2. In one example of a window apparatus 10, one or more window apparatuses 10 are installed in a compartment 4 communicating with the storeroom 2. The window apparatus 10 is provided with an automatic reception function for automatically receiving packages to be received and stowing the packages in the storeroom 2, and an automatic discharge function for automatically discharging packages to be discharged from the storeroom 2.

The package management system 1 in FIG. 1 is provided with a first door 51 for a person to enter the compartment 4, and a second door 52 for a person to enter the storeroom 2. For example, a delivery requester requesting delivery of a package enters the compartment 4 through the first door 51 and operates the window apparatus 10 to drop off the package. Additionally, a delivery company driver enters the storeroom 2 through the second door 52, takes out packages to be delivered by that driver, and performs work to load the packages onto a delivery vehicle. The window apparatus 10 is provided at the far end of the second door 52, and the automatic discharge function of the window apparatus 10 may automatically discharge packages to be received by the delivery company driver. Alternatively, the delivery company driver may enter the compartment 4 through the first door 51 and operate the window apparatus 10 installed in the compartment 4 so that the automatic discharge function of that window apparatus 10 automatically discharges packages to be received by the delivery company driver.

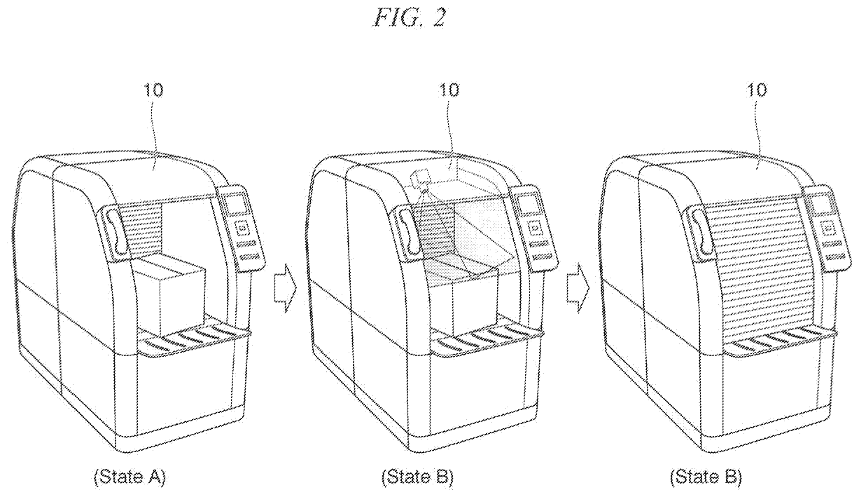

FIG. 2 is a diagram illustrating a summary of processing in the window apparatus according to the present embodiment.

The delivery requester sets a package in a receiving opening of the window apparatus 10 (state A). The delivery requester uses a terminal 40 carried by the delivery requester to show a code image indicating delivery management information to a code reader on the window apparatus 10. The delivery management information may be information that has been transmitted to the terminal 40 of the delivery requester in advance by means of web services provided by the delivery company based on registration information regarding the delivery requester which has been registered. The registration information may include information such as requester information in which the delivery requester is registered, and information such as the delivery source, the delivery destination, the name of the article being shipped, and the like. The code reader recognizes the code image and reads the delivery management information. The code reader on the window apparatus 10 may recognize a code image printed on the package to read the delivery management information.

The window apparatus 10 uses a weighing machine and a dimensional measurement apparatus to automatically measure the weight and the dimensions of the package (state B). The window apparatus 10 computes a delivery fee based on the weight and the dimensions, and displays the delivery fee on a display apparatus. Additionally, the window apparatus 10 is provided with a payment apparatus and uses monetary amount information, account information, and the like, input by the delivery requester, to perform a payment process. The window apparatus 10 may perform the payment process based on the delivery management information.

When the payment process is completed, the window apparatus 10 closes a shutter (state C). A printing apparatus on the window apparatus 10 generates receipt information based on the delivery management information, and prints and discharges the generated receipt. The receipt is taken by the delivery requester. A labeling apparatus on the window apparatus 10 prints a sorting code label based on the delivery management information, and automatically affixes the sorting code label to the package. The window apparatus 10 takes the package into the storeroom 2.

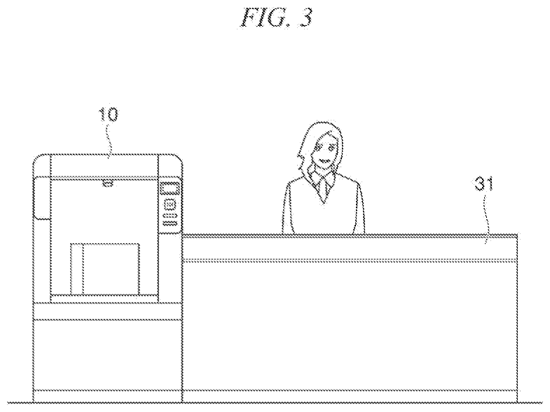

FIG. 3 is a diagram illustrating an installation example for the window apparatus according to the present embodiment.

The window apparatus 10 may be installed next to a counter 31. An employee for performing package receiving work in a convenience store or the like may be posted at the counter 31. The window apparatus 10 may be provided near a cash register of a package receiving business such as a convenience store.

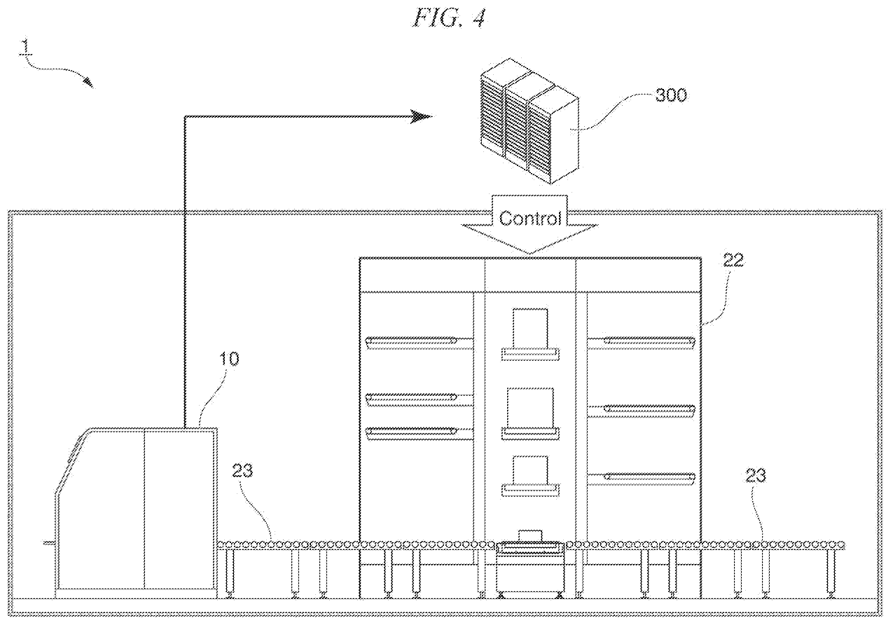

FIG. 4 is a diagram illustrating details of the package management system according to the present embodiment.

The package management system 1 is further provided with a storeroom control apparatus 300. The storeroom control apparatus 300 controls a stowing apparatus 22 and a belt conveyor 23 provided in the storeroom 2. When taking a package into the storeroom 2, the window apparatus 10 transmits the delivery management information to the storeroom control apparatus 300. Based on the reception of the delivery management information, the storeroom control apparatus 300 controls the belt conveyor 23 and the stowing apparatus 22 to convey the package to a prescribed position in the stowing apparatus 22. The stowing apparatus 22 may be provided with a structure that can arrange packages three-dimensionally. Although FIG. 4 only shows a single window apparatus 10, a plurality of window apparatuses 10 are provided in the package management system. Each window apparatus 10 is communicatively connected with the storeroom control apparatus 300 and is connected to the belt conveyor 23.

The window apparatus 10 discharges a package stowed in the storeroom 2 based on operations by a delivery worker. At this time, the window apparatus 10 reads delivery management information and the like including the delivery management information that a person in charge, such as a driver of a delivery vehicle of the delivery company, has displayed and presented on the terminal 40 or the like. The window apparatus 10 outputs the delivery management information that has been read to the storeroom control apparatus 300. Based on the delivery management information, the storeroom control apparatus 300 identifies packages to be discharged that are stowed in the stowing apparatus 22, and controls the stowing apparatus 22 and the belt conveyor 23 so that those packages are discharged. The window apparatus 10 discharges the packages that have been conveyed by the belt conveyor 23 from a discharge opening one at a time. The delivery company worker loads the packages that have been discharged from the discharge opening onto the cargo bed of a delivery vehicle. The delivery company worker drives the delivery vehicle and delivers the packages to delivery destinations.

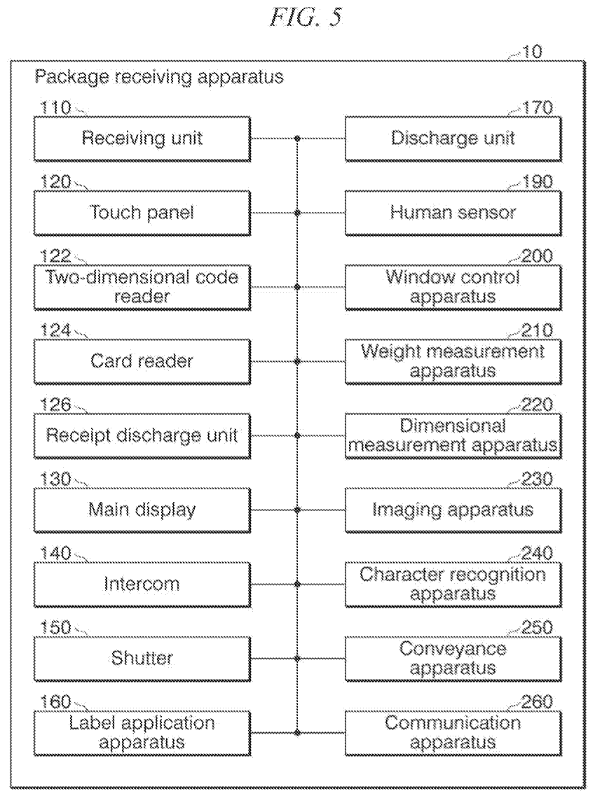

FIG. 5 is a diagram illustrating a schematic structure of a window apparatus according to the present embodiment.

The window apparatus 10 is provided with a receiving unit 110, a touch panel 120, a two-dimensional code reader 122, a card reader 124, a receipt discharge unit 126, a main display 130, an intercom 140, a shutter 150, a label application apparatus 160, and a discharge unit 170. Furthermore, the window apparatus 10 is provided with a human sensor 190, a window control apparatus 200, a weight measurement apparatus 210, a dimensional measurement apparatus 220, an imaging apparatus 230, a character recognition apparatus 240, a conveyance apparatus 250, and a communication apparatus 260.

The communication apparatus 260 is composed of a communication module or the like supporting a wired or wireless communication standard such as Ethernet (registered trademark) or Wi-Fi (registered trademark). The communication apparatus 260 is an apparatus for communicating between the window apparatus 10 and other apparatuses such as a delivery company server 30. The details regarding other parts will be described below.

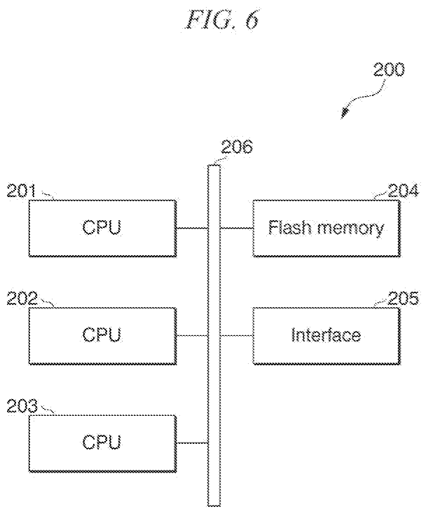

FIG. 6 is a diagram illustrating a hardware structure of the window control apparatus (FIG. 5) according to the present embodiment.

The window control apparatus 200 is a computer provided with functions for computation, control, and storage, and mainly controls the window apparatus 10. The window control apparatus 200 may be a server, a PC (Personal Computer), a microcomputer, a PLC (Programmable Logic Controller), or the like. Additionally, the window control apparatus 200 may be composed of multiple items of hardware, such as by combining a PC for controlling the window apparatus 10 overall and a PLC for controlling the mechanical parts.

The window control apparatus 200 is provided with a CPU (Central Processing Unit) 201, a RAM (Random Access Memory) 202, a ROM (Read-Only Memory) 203, a flash memory 204, and an interface 205. The CPU 201, the RAM 202, the ROM 203, the flash memory 204, and the interface 205 are connected to each other by a bus 206. The window control apparatus 200 may be provided with a drive apparatus, not illustrated, for driving each part.

In FIG. 6, each part constituting the window control apparatus 200 is illustrated as a single apparatus. However, some of these functions may be provided by means of external apparatuses.

The CPU 201 is a processor that performs prescribed computations in accordance with a program stored in the ROM 203, the flash memory 204, or the like, and that also has the function of controlling the respective parts of the window apparatus 10. The RAM 202 is composed of a volatile storage medium and provides a temporary memory area required for operating the CPU 201. The ROM 203 is composed of a non-volatile storage medium, and stores required information, such as a program used to operate the window control apparatus 200. The flash memory 204 is a storage apparatus that is composed of a non-volatile storage medium and that stores acquired information, a program for operating the window control apparatus 200, and the like.

The interface 205 is a communication interface based on a standard such as Ethernet (registered trademark), Wi-Fi, Bluetooth (registered trademark), USB (Universal Serial Bus), RS-232C (Recommended Standard 232 version C), or the like. The interface 205 is composed of a communication module or the like supporting various communication standards. The interface 205 is used for communication between the window control apparatus 200 and the parts in the window apparatus 10.

The hardware structure shown in FIG. 6 is illustrative, and apparatuses aside from those shown may be added, and some of the apparatuses do not need to be provided. For example, the window control apparatus 200 may have a display apparatus such as a display, or an input apparatus for receiving operations from a user. Additionally, some of the apparatuses in the window control apparatus 200 may be replaced with other apparatuses having similar functions. For example, the flash memory 204 may be replaced with an HDD (Hard Disk Drive) or the like. Furthermore, some of the functions of the window control apparatus 200 in the present embodiment may be provided by other apparatuses through a network. Additionally, the functions of the window control apparatus 200 of the present embodiment may be realized by being distributed between multiple apparatuses. For example, the flash memory 204 may be replaced with cloud storage.

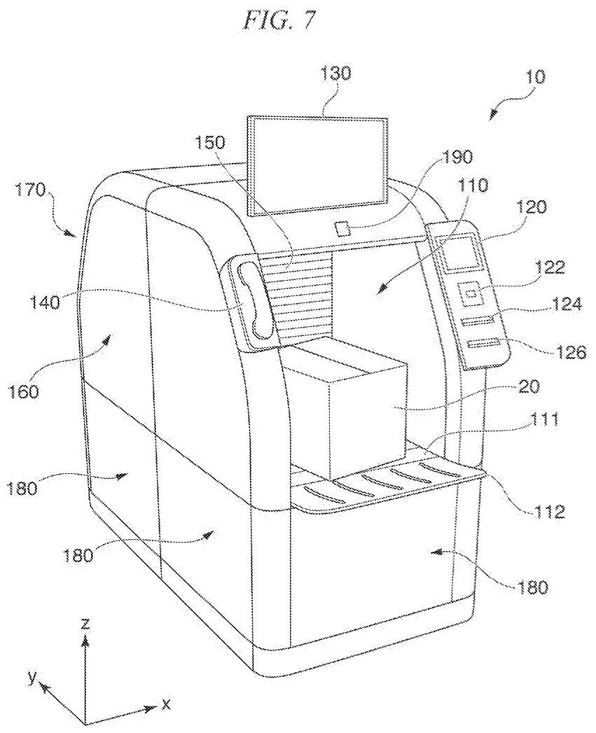

FIG. 7 is an overall perspective view of the window apparatus according to the present embodiment.

The coordinate axes indicated in the drawing have been provided for convenience of explanation.

The receiving unit 110 is a portion for receiving a package carried in by a delivery requester, and includes an opening portion of the window apparatus 10, and a placement unit 111 provided on the inner side thereof. The opening portion of the receiving unit 110 will sometimes be referred to as a receiving opening. The delivery requester places the package 20 on the placement unit 111 in the receiving unit 110. FIG. 7 indicates the state immediately after the delivery requester has placed the package 20 on the placement unit 111. Additionally, guides 112 arranged to be at a height close to that of the placement unit 111 are provided on the receiving unit 110. By first placing the package 20 on the guides 112, and thereafter moving the package 20 so as to slide onto the placement unit 111, the delivery requester can smoothly place the package 20. The placement unit 111 is provided with a belt conveyor, which is the conveyance apparatus 250 (FIG. 5), and the package 20 that is placed on the placement unit 111 is conveyed, by the belt conveyor, towards the far side (the positive y-axis direction) of the window apparatus 10. The conveyance apparatus 250 may be an apparatus other than the belt conveyor 23, as long as it can convey the package 20, and may, for example, be a roller conveyor, a chain conveyor or the like.

The touch panel 120 is a liquid crystal display, an OLED (Organic Light Emitting Diode) display or the like, and is used to display a GUI (Graphical User Interface) or the like for inputting operations. Additionally, touch sensors supporting touch operations are provided on the display surface of the touch panel 120. As a result thereof, the touch panel 120 is provided with both a display function and a function for receiving inputs. The delivery requester can input the information required for a delivery request, such as the name of the delivery requester, the address of the delivery requester, and the name and address of the delivery recipient, by operating the touch panel 120.

The input method to the touch panel 120 may involve inputting the abovementioned information as text. However, the touch panel 120 may display multiple information candidates extracted from such information as delivery requester IDs (Identifiers), information read from the package 20, and the past history of the delivery requester, and have the user select therefrom.

The two-dimensional card reader 122 is an apparatus for reading a two-dimensional code, such as a QR code (registered trademark), sent from the delivery company server 30 to the terminal in the case in which information such as an address has been pre-registered in the delivery company server 30. The delivery requester displays the two-dimensional code on the terminal owned by the delivery requester, and shows the two-dimensional code to the two-dimensional code reader 122. As a result thereof, the delivery requester can make the two-dimensional code reader 122 read the information held in the two-dimensional code. A process making use of a two-dimensional code will be explained below.

The card reader 124 is an apparatus for reading information from a card or a terminal supporting electronic payments, such as a credit card, a debit card, a prepaid card, an electronic money card, or a mobile terminal having a contactless communication function. The card reader 124 may, for example, be an apparatus that supports the reading of information stored in a magnetic stripe card, an IC (Integrated Circuit) card, or the like, and the manner of reading may be either with contact or contactless. Thus, the card reader 124 functions as a payment unit for the window apparatus 10, and allows unattended payments to be made.

The receipt discharge unit 126 is a printing apparatus that prints and discharges a receipt after a package has been received by the window apparatus 10. The receipt describes that the package 20 has been received, the type of the package 20, the dimensions of the package 20, the weight of the package 20, a tracking number for the package 20, the reception date/time, an identification number of the window apparatus 10, an issue number for the receipt, contact information, and the like. The issue number of the receipt, the tracking number of the package 20, and the like are associated with the package 20, and the delivery requester may reference the package 20 by accessing the delivery company server 30 and inputting these numbers.

The main display 130 is a display, such as a liquid crystal display or an OLED display, larger than the touch panel 120. The main display 130 is used to notify the delivery requester of information, such as by displaying a message to the delivery requester.

The intercom 140 is a telephone for making inquiries to a call center operator or staff managing the window apparatus 10. The window apparatus 10 is configured so that, in principle, the delivery requester can perform drop-off work for the package 20 alone. Thus, there is usually no need to notify staff or the like. However, if there is something unclear about operation, if a malfunction occurs, or the like, then it might become required to make an inquiry. Therefore, an intercom 140 is provided on the window apparatus 10.

The label application apparatus 160 is an apparatus for preparing a label by printing prescribed information on adhesive paper or the like, and applying the label to the package 20 conveyed into the interior of the window apparatus 10. Information such as an address required for delivery to the destination, and identification information or the like, such as a barcode, required for automatically sorting the package 20 at a package collection area, is printed on this label. The label application apparatus 160 is provided with a perpendicular transfer mechanism, a positioning plate, a label application arm, and the like. The label application apparatus 160 moves the package 20 in the x direction by means of the perpendicular transfer mechanism and positions the package 20 so as to be aligned with the positioning plate, then applies a label by pressing the label onto the package 20 with the label application arm.

The discharge unit 170 has an opening portion of the window apparatus 10 for discharging the package 20 on which label application has been completed. The opening portion of the discharge unit 170 will sometimes be referred to as a discharge opening. The opening portion of the discharge unit 170 is not illustrated, but has a form similar to that of the receiving unit 110. A belt conveyor 23 for further conveying the package 20 that has been discharged from the discharge unit 170 is installed. The package 20 discharged from the discharge unit 170 is automatically moved onto the belt conveyor 23 and conveyed to the storeroom 2 by means of the belt conveyor 23. This belt conveyor 23 may be an apparatus other than a belt conveyor as long as it can convey the package 20, and may, for example, be a roller conveyor, a chain conveyor or the like.

The human sensor 190 is a sensor that is disposed on the front surface of the window apparatus 10 and that detects whether or not a person, such as a delivery requester, is at the front surface of the window apparatus 10. The human sensor 190 may, for example, be an infrared sensor, an optical sensor, a capacitive sensor, or the like.

Under the receiving unit 110, the label application apparatus 160, and the discharge unit 170, a support unit 180 for supporting these parts is provided. The support unit 180 is covered by a housing of the window apparatus 10, and the window control apparatus 200, the communication apparatus 260, and apparatuses that are not illustrated, such as driving apparatuses for the respective apparatuses, may be arranged in a space inside the housing.

Additionally, under the support unit 180, casters may be provided, and in that case, the window apparatus 10 can be made movable. This structure is effective for the case in which the installation location of the window apparatus 10 may be moved.

The shutter 150 is a screening member that is movably provided on the front surface of the receiving unit 110 (first shutter position), or between the receiving unit 110 and the label application apparatus 160 (second shutter position). The shutter 150 can move between the first shutter position and the second shutter position in response to control by the window control apparatus 200. Hereinafter, the state in which the shutter 150 is at the second shutter position may be referred to as the open state, and the state in which the shutter 150 is at the first shutter position may be referred to as the closed state. Additionally, moving the shutter 150 to the second shutter position may be expressed as “opening the shutter 150”, and moving the shutter 150 to the first shutter position may be expressed as “closing the shutter 150”.

The window apparatus 10 may be of a size such that the z-direction height is approximately 150 cm, and the z-direction height of the support unit 180 is approximately 50 cm.

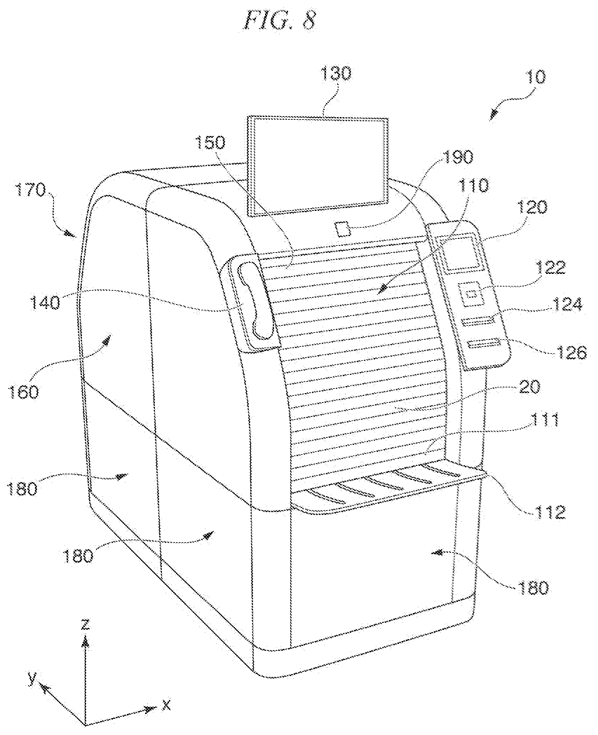

FIG. 8 is an overall perspective view of the window apparatus according to the present embodiment.

FIG. 8 is an overall perspective view of the window apparatus 10 in the case in which the shutter 150 is in the closed state. When the window apparatus 10 is not being used, as indicated in FIG. 8, the shutter 150 protects the inside of the apparatus by covering the receiving unit 110. Additionally, the shutter 150 enters the closed state in cases in which the drive unit of the window apparatus 10 is being moved, such as while the conveyance apparatus 250 is conveying a package. As a result thereof, the delivery requester cannot touch the inside of the window apparatus 10, thus improving safety. Additionally, in the case in which the shutter 150 is in the closed state, the shutter 150 is located in front of the label application apparatus 160, and has the function of protecting the inside of the label application apparatus 160 while allowing access to the receiving unit 110.

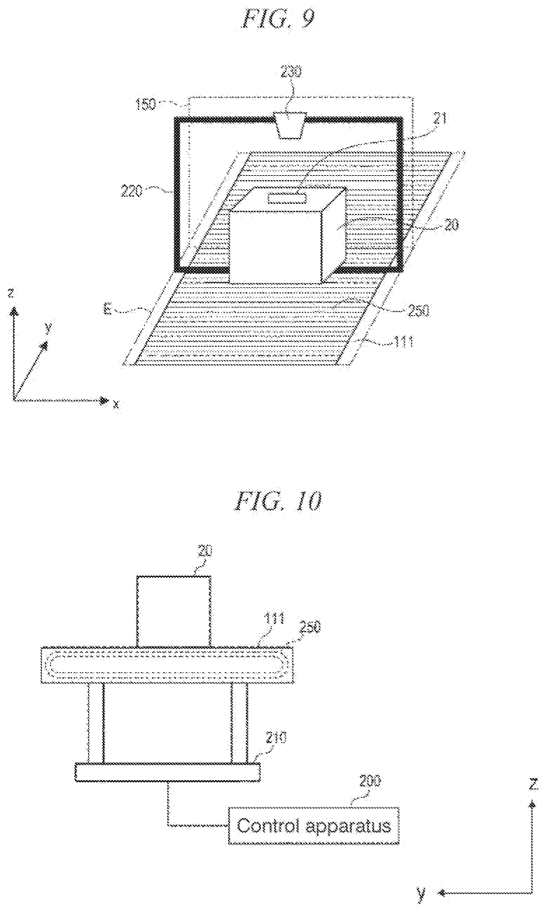

FIG. 9 is a schematic diagram illustrating the conveyance of a package in the window apparatus according to the present embodiment.

In order to show the interior mechanisms in the window apparatus 10, the components that are unnecessary for explaining the conveyance of the package 20, such as the housing of the window apparatus 10, are not illustrated in FIG. 9.

The conveyance apparatus 250 is the belt conveyor 23 (FIG. 4) for conveying the package 20 in the positive or negative y-axis direction. FIG. 9 shows the state in which the package 20 is in the process of being conveyed in the positive y-axis direction. The single-dotted chain lines E in the drawing indicate the positions of the inner walls of the housing. Additionally, the dashed lines in the drawing indicate the position of the shutter 150 in the open state.

FIG. 10 is a section view illustrating the structure of the placement unit in the window apparatus according to the present embodiment.

FIG. 10 shows a y-z cross-section near the placement unit 111. The structure of the weight measurement apparatus 210 (FIG. 5) will be explained by referring to FIG. 9 and FIG. 10.

The weight measurement apparatus 210 is configured so as to include a weight sensor that generates a signal in response to a load. The weight measurement apparatus 210 is attached below the placement unit 111 so as to be able to measure the load from the package 20 and the placement unit 111 when the package 20 is placed on the placement unit 111. The signal generated by the weight measurement apparatus 210 is transmitted from the weight measurement apparatus 210 to the window control apparatus 200 and is stored, as data indicating the weight of the package 20, in a storage apparatus, such as the flash memory 204, in the window control apparatus 200. Thus, the weight measurement apparatus 210 functions as a weight acquisition unit in the window apparatus 10. In the step of acquiring the weight, the window control apparatus 200 or the weight measurement apparatus 210 performs a process for acquiring the net weight of the package 20 by subtracting the weight of the placement unit 111.

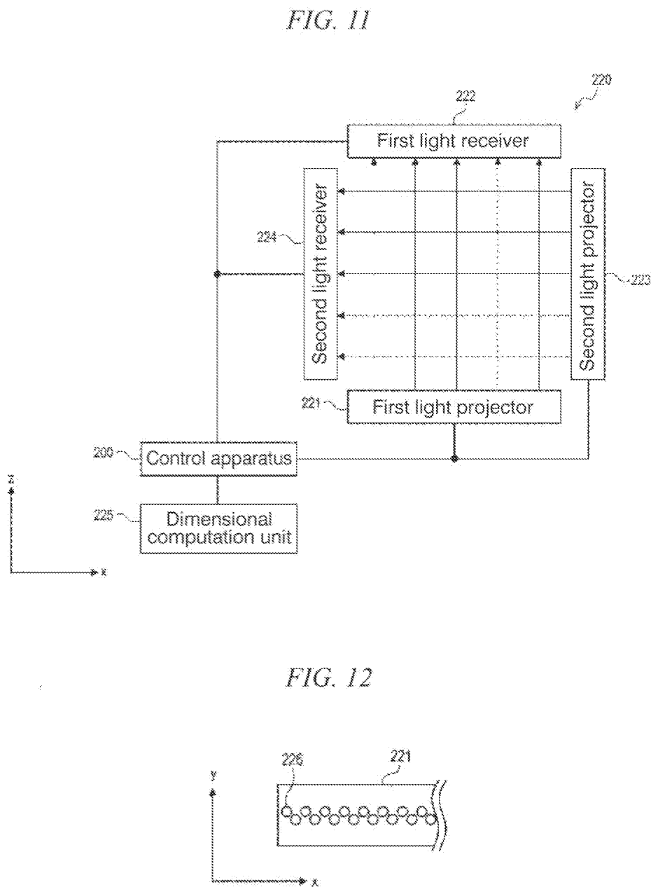

FIG. 11 is a schematic view illustrating the structure of the dimensional measurement apparatus (FIG. 5) according to the present embodiment.

FIG. 12 is a schematic view illustrating the structure of a first light projector in the dimensional measurement apparatus according to the present embodiment.

The structure of the dimensional measurement apparatus 220 will be explained by referring to FIG. 9, FIG. 11, and FIG. 12. The dimensional measurement apparatus 220 is provided with a first light projector 221, a first light receiver 222, a second light projector 223, a second light receiver 224, and a dimensional computation unit 225. The first light projector 221, the first light receiver 222, the second light projector 223, and the second light receiver 224 are controlled by the window control apparatus 200. The window control apparatus 200 functions as a dimensional computation unit 225 by executing a program stored in memory or the like. Alternatively, the dimensional computation unit 225 may be composed of hardware separate from the window control apparatus 200.

As illustrated in FIG. 12, the first light projector 221 is provided with multiple light-emitting elements 226 arrayed in the x direction. The light-emitting elements 226 are, for example, LEDs (Light-Emitting Diodes) that emit infrared light. The light-emitting elements 226 are in a staggered arrangement. As a result thereof, the pitch in the x direction can be made smaller in comparison with the case in which the light-emitting elements 226 are arrayed in a straight line, thus allowing the dimensional measurement resolution to be increased. The x-direction pitch of the light-emitting elements 226 is, for example, 5 mm. As a result thereof, the dimensions of the package 20 can be measured with a resolution of approximately 5 mm.

The multiple light-emitting elements 226 on the first light projector 221 each generate light parallel to the positive z-axis direction. The first light receiver 222 has multiple light-receiving elements corresponding respectively to the light-emitting elements 226. The light-receiving elements are, for example, photodiodes that receive infrared rays and generate electrical signals. The light-receiving elements are arrayed similarly to the light-emitting elements 226 illustrated in FIG. 12, so a detailed description of the arrangement of the light-receiving elements on the first light receiver 222 will be omitted.

The multiple light-emitting elements 226 on the second light projector 223 each emit light parallel to the negative x-axis direction. The second light receiver 224 has multiple light-receiving elements corresponding respectively to the light-emitting elements 226. The structures of the second light projector 223 and the second light-receiver 224 are respectively the same as the first light projector 221 and the first light receiver 222.

When the package 20 passes through a detection area surrounded by the first light projector 221, the first light receiver 222, the second light projector 223, and the second light receiver 224, some of the light emitted by the light-generating elements 226 is blocked by the package 20. For this reason, the amount of light detected by the light-receiving elements in the range blocked by the package 20 becomes lower. By counting the number of light-receiving elements in which the detected light amount is lower, the dimensional computation unit 225 can measure the width (dimension in the x direction) and the height (dimension in the z direction) of the package 20.

Additionally, the dimensional computation unit 225 can measure the length (dimension in the y direction) of the package 20 by multiplying the time period during which the amount of detected light in the light-receiving elements was lower by the conveyance speed of the conveyance apparatus 250. As a result thereof, the dimensional computation unit 225 can acquire the width, length, and height dimensions of the package 20. The dimensions of the package 20 are stored in a storage apparatus such as the flash memory 204. Thus, the dimensional measurement apparatus 220 functions as a dimensions acquisition unit for the window apparatus 10.

Returning to FIG. 9, the imaging apparatus 230 will be explained. The imaging apparatus 230 is an apparatus, such as a camera, for acquiring an image of the package 20. The imaging apparatus 230 is arranged to be able to capture an image of a sending form 21 applied to the top surface of the package 20 being conveyed by the conveyance apparatus 250. The sending form 21 is a label on which information required for a delivery request, such as the name of the delivery requester, the address of the delivery requester, and the name and address of the delivery recipient, is written in a prescribed format. The delivery requester prepares the sending form 21 in advance and applies the form to the top surface of the package 20.

The image of the sending form 21 captured by the imaging apparatus 230 is stored in a storage apparatus such as the flash memory 204. Thereafter, the character recognition apparatus 240 (FIG. 5) recognizes the characters written on the sending form 21 based on the image of the sending form 21. The character recognition apparatus 240 is a computer having an OCR (Optical Character Recognition) function. The character recognition apparatus 240 may be a computer separate from the window control apparatus 200. Additionally, the character recognition apparatus 240 may be configured by the window control apparatus 200 executing an OCR program and thereby functioning as a character recognition apparatus 240. The functions of the character recognition apparatus 240 may be included in the interior of the window apparatus 10. Alternatively, the character recognition apparatus 240 may be provided outside the window apparatus 10.

The character recognition apparatus 240 acquires, as text data, the information required for a delivery request, such as the name of the delivery requester, the address of the delivery requester, and the name and address of the delivery recipient, and stores the information in a storage apparatus such as the flash memory 204. In this way, the imaging apparatus 230 and the character recognition apparatus 240 function as a destination address acquisition unit for the window apparatus 10. Additionally, the character recognition apparatus 240 may further acquire information identifying the delivery company based on the image of the sending form 21.

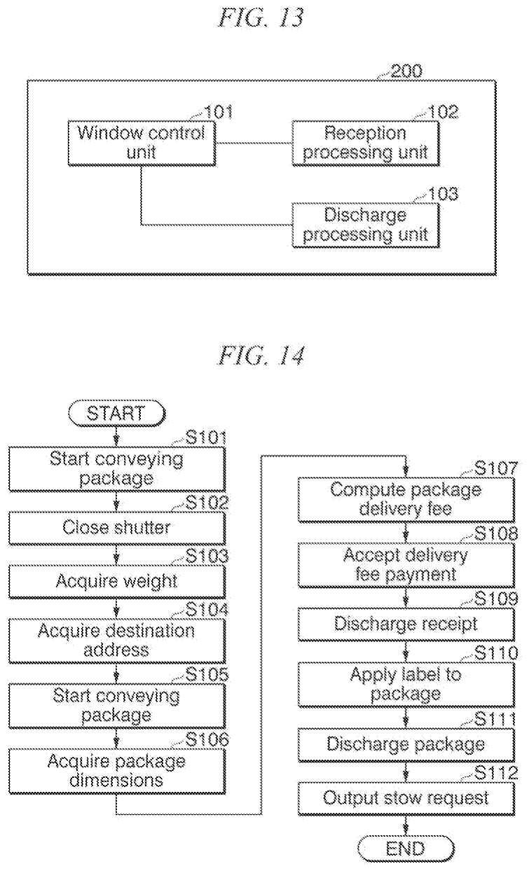

FIG. 13 is a functional block diagram of the window control apparatus according to the present embodiment.

The CPU 210 in the window control apparatus 200 executes a window control program that is pre-stored in the window control apparatus 200. As a result thereof, the window control apparatus 200 performs the functions of a window control unit 101, a reception processing unit 102, and a discharge processing unit 103.

The window control unit 101 controls the functional units of the window control apparatus.

The reception processing unit 102 transmits delivery management information relating to a package to the storeroom control apparatus 300 (FIG. 4) that is a transmission destination, and performs a process for receiving the package.

The discharge processing unit 103 acquires delivery management information and performs processes for discharging the package associated with said delivery management information from the storeroom.

FIG. 14 is a first diagram illustrating the processing flow in the window apparatus according to the present embodiment.

The package receiving process executed by the window apparatus 10 will be explained with reference to FIG. 14.

The process indicated in FIG. 14 is started when a need to receive a package 20 arises, such as when the human sensor 190 has detected the approach of a delivery requester. Other examples of when the need to receive a package arises include when a delivery requester has touched the touch panel 120, when a delivery requester has brought a package 20 close to the receiving unit 110, and the like.

In a period before the need to receive the package arises, the shutter 150 may be in a closed state. In that case, the window control apparatus 200 implements control to open the shutter 150 when the need to receive a package 20 arises. Additionally, in the period before the need to receive the package 20 arises, the window apparatus 10 may be in a sleep state in which some of its functions are restricted. In that case, the window control apparatus 200 controls the window apparatus 10 so as to be revived from the sleep state when the need to receive the package 20 arises.

The weight measurement apparatus 210, the imaging apparatus 230, and the like detect the placement of a package 20 based on control by the window control apparatus 200 (step S101). After the placement of the package 20 has been detected, the process shifts to step S102. The package 20 may be detected, for example, by the weight measurement apparatus 210 detecting the weight of the package 20, or by analyzing an image captured by the imaging apparatus 230. Additionally, a package-detecting sensor may further be provided. In this case, the placement of the package 20 can be detected by locating the detection area of the package-detecting sensor near the placement unit 111. When the package 20 is detected, the reception processing unit 102 in the window control apparatus 200 starts the reception process below.

The reception processing unit 102 controls the shutter 150 to perform a process for closing the shutter 150 (step S102). The shutter 150 is closed with the package 20 in a state of placement on the placement unit 111. As a result thereof, the delivery requester cannot touch the inside of the window apparatus 10 when the drive unit of the window apparatus 10 is moving, thus improving the safety. Additionally, the delivery requester can be prevented from carrying away the package 20 during the process. The timing by which the shutter 150 is closed may be another timing.

The weight measurement apparatus 210 acquires the weight of the package 20 on the basis of control by the reception processing unit 102 (step S103). The weight that has been acquired is transmitted to the reception processing unit 102 and stored in the flash memory 204.

The imaging apparatus 230 and the character recognition apparatus 240 acquire information required for the delivery request, including the destination address of the package 20, from the sending form 21 affixed to the package 20, based on control by the reception processing unit 102 (step S104). The acquired information, such as the destination address, is transmitted to the reception processing unit 102 and stored in the flash memory 204.

The conveyance apparatus 250 starts conveying the package 20 based on control by the reception processing unit 102 (step S105). The dimensional measurement apparatus 220 acquires the width, length, and height dimensions of the package 20 based on control by the window control apparatus 200 (step S106). The acquired dimensions are transmitted to the window control apparatus 200 and stored in the flash memory 204.

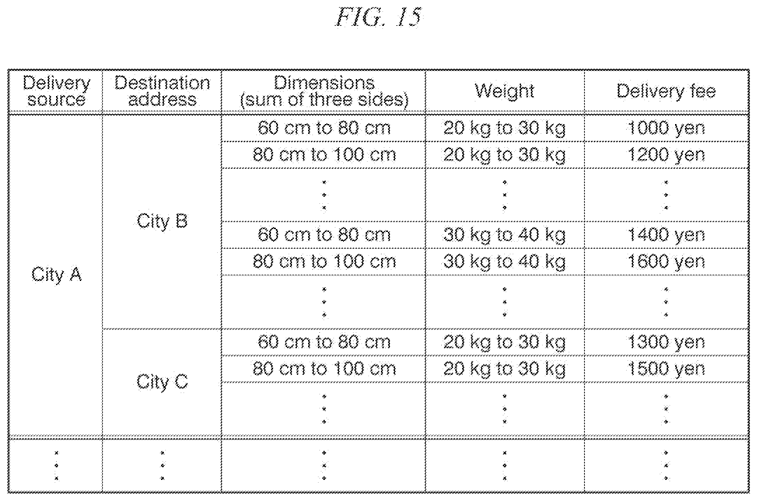

The reception processing unit 102 computes the delivery fee of the package 20 based on the weight, destination address, and dimensions of the package 20 (step S107). The delivery fee computation method will be explained by referring to FIG. 15.

FIG. 15 is an example of a table used to compute the delivery fee in the present embodiment.

As indicated in FIG. 15, the delivery fee is determined on the basis of the location of the delivery source, the destination address, the sum of the three sides, i.e., the width, the length, and the height of the package 20, the weight of the package 20 and the like. A table as indicated in FIG. 15 is pre-stored in the flash memory 204. Additionally, the delivery source is the same as the installation location of the window apparatus 10, and thus is established beforehand and stored in the flash memory 204. Therefore, based on the acquired destination address, weight, width, length, and height information, the reception processing unit 102 computes the sum of the width, length, and height, and refers to the table in FIG. 15. Due to this process, the reception processing unit 102 can automatically acquire the delivery fee. Thus, the reception processing unit 102 functions as a delivery fee computation unit for the window apparatus 10, thereby achieving automatic computation of the delivery fee.

The delivery fee computation method based on referring to a table is merely one example, and the delivery fee may be computed by another method. For example, the delivery fee may be computed by a pre-defined function, or may be acquired by transmitting information to another server and making a query.

The reception processing unit 102 displays the delivery fee on the touch panel 120 or the main display 130, and prompts the delivery requester to pay the delivery fee. Furthermore, the reception processing unit 102 drives the card reader 124 in a state in which electronic payments can be accepted. When the delivery requester makes an electronic payment by having the card reader 124 read an NFC (Near-Field Communication) card or the like, the window control apparatus 200 determines whether or not the delivery fee computed based on the acquired destination address, weight, width, length, and height has been correctly paid. If the delivery fee has been correctly paid, then the reception processing unit 102 accepts that payment in the card reader (step S108).

The reception processing unit 102 instructs the receipt discharge unit 126 to print a receipt. As a result thereof, the receipt discharge unit 126 prints and discharges a receipt (step S109).

The reception processing unit 102 instructs the label application apparatus 160 to print a label and affix the printed label. The label application apparatus 160 prints the label and applies the label to the package 20 (step S110). During this process, the conveyance apparatus 250 guides the package 20 to a position appropriate for applying the label based on control by the reception processing unit 102.

The reception processing unit 102 controls the conveyance apparatus 250 and provides an instruction that the package 20 is to be stowed in the storeroom 2. The conveyance apparatus 250 further moves the package 20 in the positive y-axis direction and conveys the package 20 from the discharge unit 170 towards the storeroom 2 based on control by the reception processing unit 102 (step S111). The reception processing unit 102 acquires information such as the dimensions, weight and destination address of the package, and generates delivery management information including that information. The delivery management information may further include the name of the delivery requester, contact information, and a reception number. The reception processing unit 102 outputs a stow request including the delivery management information to the storeroom control apparatus 300 that is to be the transmission destination apparatus (step S112). The storeroom control apparatus 300 uses the belt conveyor 23 to convey the package 20 to the stowing apparatus 22 in the storeroom 2.

The window apparatus 10 in the present embodiment can receive a package 20 carried in by a delivery requester, and automatically acquire the weight, destination address and dimensions of the package 20, which are required to compute the delivery fee and the like. Therefore, the present embodiment provides a window apparatus 10 that can automatically acquire information required for automatic reception of a package.

Additionally, the window apparatus 10 of the present embodiment can automatically acquire the weight, destination address and dimensions of the package 20 at the time of reception. As a result thereof, the actual weight, destination address and dimensions of the package 20 can be reliably acquired in comparison to the case in which this information is acquired at a timing other than at the time of reception, such as in the case of directly using a weight, destination address, and dimensions that have been registered before reception of the package 20.

For the above-described process, the case in which the window apparatus 10 receives the package 20 by acquiring the weight, destination address, and dimensions of the package 20 was explained. However, the delivery requester may pre-register the weight, destination address, and dimensions, and the window apparatus 10 may perform the reception process based on delivery management information transmitted to the terminal 40 of the delivery requester as a result of the pre-registration.

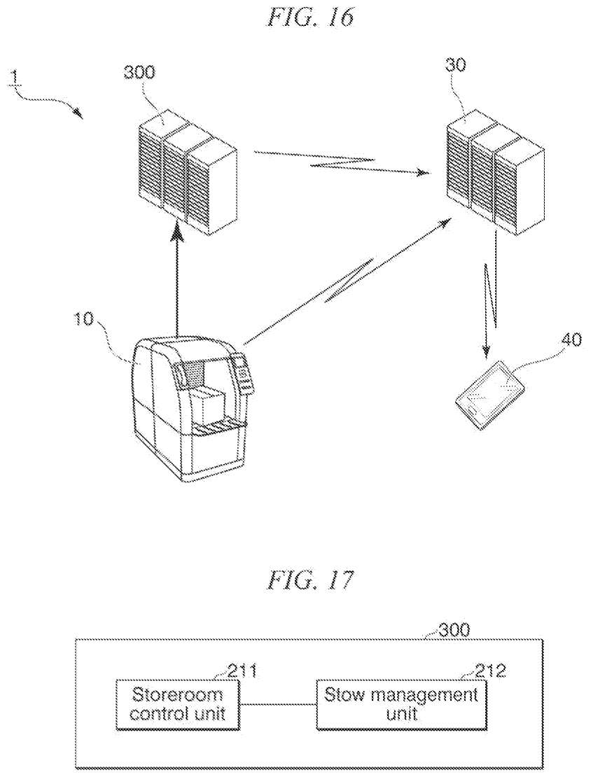

FIG. 16 is a diagram illustrating another structural example of the package management system according to the present embodiment.

The window apparatus 10 and the storeroom control apparatus 300 are connected to the delivery company server 30 via a communication network. The delivery company server 30 has a web server function and is connected to the internet. The delivery requester owns the terminal 40. The delivery requester uses the terminal 40 to connect to a web service provided by the delivery company server 30 via the internet. The delivery company server 30 may perform a process for managing packages based on information acquired from the window apparatus 10 or the storeroom control apparatus 300.

The web server function in the delivery company server 30 provides a web service for pre-registration information required for determining the delivery fee, such as the weight, the destination address, and the dimensions of the package 20 that the delivery requester is requesting to have delivered, as well as information required for delivery, such as the name and address of the delivery requester, the name and address of the delivery recipient, and the like. The pre-registration may be performed by using application software for registration distributed by the delivery company, or by accessing a website for pre-registration.

FIG. 17 is a functional block diagram of a storeroom control apparatus according to the present embodiment.

The storeroom control apparatus 300 is a computer server. Therefore, the storeroom control apparatus 300 is provided with hardware such as a CPU (Central Processing Unit), a ROM (Read-Only Memory), a RAM (Random Access Memory), a database, a communication module, or the like.

Furthermore, the CPU of the storeroom control apparatus 300 executes a storeroom control program. As a result thereof, the storeroom control apparatus 300 is provided with a storeroom control unit 211 and a stow management unit 212. The storeroom control unit 211 controls the stow management unit 212. The stow management unit 212 controls the belt conveyor 23 and the stowing apparatus 22 provided in the storeroom 2.

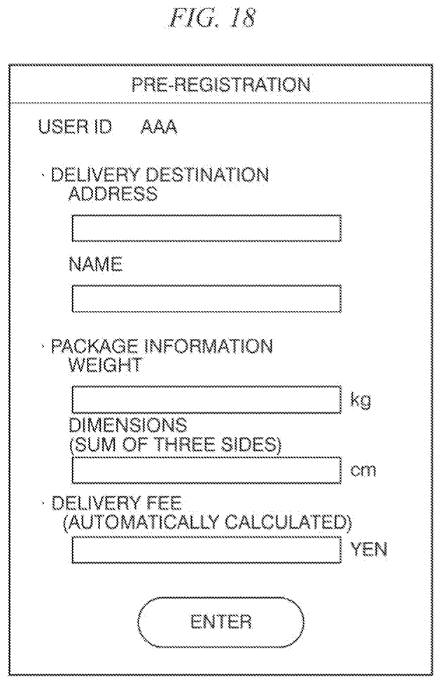

FIG. 18 is a diagram illustrating a pre-registration screen according to the present embodiment.

The delivery requester operates the terminal 40 to communicatively connect the terminal 40 with the delivery company server 30. The web server function of the delivery company server 30 transmits data for a login screen to the terminal 40. The delivery requester operates the terminal 40 and inputs the delivery requester's own ID (user ID AAA) into the login screen displayed on the terminal 40. As a result thereof, the terminal 40 logs in to a pre-registration web service provided by the web server function. Then, the delivery company server 30 transmits data for a pre-registration screen as indicated in FIG. 18 to the terminal 40, and the terminal 40 displays a screen based on the pre-registration data. For example, when the address and the name of the delivery destination and the weight and dimensions (sum of three sides) of the package 20 are input by the delivery requester, the terminal 40 automatically calculates the delivery fee and displays it on the screen. In this case, the weight and dimensions input by the delivery requester are not those measured by the window apparatus 10, but are rather a weight and dimensions measured by the delivery requester using a weighing machine, measuring tape, or the like.

When the delivery requester presses an enter button on the pre-registration screen, the terminal 40 transmits the input information to the delivery company server 30. The delivery company server 30 stores the received information in a database or the like in association with the ID of the delivery requester. As a result thereof, the pre-registration is completed. When the enter button is pressed, an electronic payment is made by means of the delivery requester's credit card or the like. Although the name, address, payment information (credit card number, etc.), etc. of the delivery requester are pre-registered in the delivery company server 30 when registering the user ID, input areas for inputting these may further be added to the pre-registration screen.

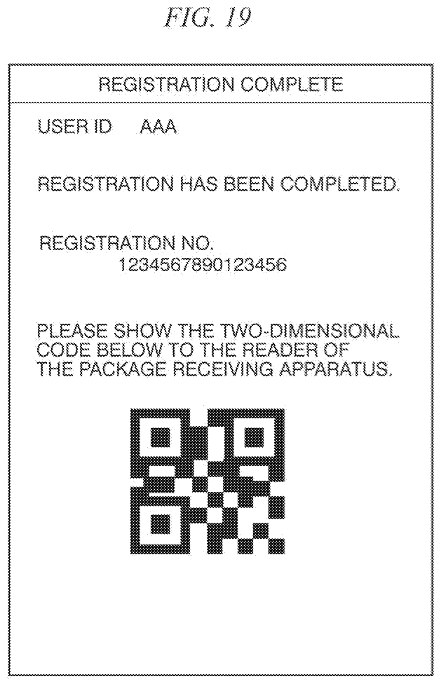

FIG. 19 is a diagram illustrating a registration complete screen according to the present embodiment.

When the delivery requester presses the enter button and the registration is completed, the delivery company server 30 generates a reception number and a two-dimensional code, and transmits data for the registration complete screen, including the reception number and the two-dimensional code, to the terminal 40. This reception number is identification information uniquely corresponding to the package 20 that is scheduled to be delivered. Additionally, the two-dimensional code includes the reception number or information corresponding thereto. The two-dimensional code further includes delivery management information required for delivering the package 20 or sorting the package 20, such as an address, a postal code, or the like.

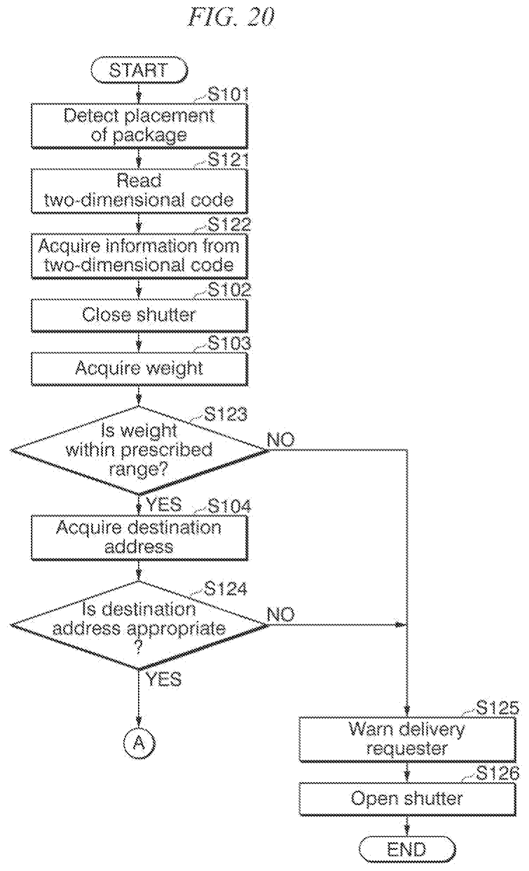

FIG. 20 is a second diagram illustrating a processing flow of the window apparatus according to the present embodiment.

FIG. 21 is a third diagram illustrating a processing flow of the window apparatus according to the present embodiment.

Another reception process for the package 20 performed by the window apparatus 10 will be explained with reference to FIG. 20 and FIG. 21. In the respective steps in the flow charts in FIG. 20 and FIG. 21, those labeled with reference numbers that are the same as those in the flow chart indicated in FIG. 14 involve the same processes. Thus, their explanations will be omitted or simplified.

The processes in FIG. 20 and FIG. 21 similarly start when the need to receive a package arises, such as with the approach of a delivery requester. The detection of the placement of a package in step S101 is similar to that in the above-mentioned process in FIG. 14. The delivery requester displays data for the registration complete screen shown in FIG. 19 on the terminal 40. Then, the delivery requester shows the screen of the terminal 40 to the two-dimensional code reader 122. The two-dimensional code reader 122, based on control by the window control apparatus 200, performs a process for reading the two-dimensional code displayed on the terminal 40 carried by the delivery requester (step S121). Before this process, the window control unit 101 in the window control apparatus 200 may implement control to display, on the touch panel 120 or the main display 130, a message prompting the delivery requester to show the two-dimensional code to the two-dimensional code reader 122. This message to be displayed may, for example, be a message such as: “Please display the two-dimensional code on your smartphone and show it to the reading unit”.

The order of step S101 and step S121 may be reversed, or it may be made possible to accept both steps and the order may be selected by the delivery requester.

The two-dimensional code reader 122 acquires delivery management information including a destination address or the like from the acquired two-dimensional code (step S122). The acquired delivery management information is transmitted to the window control apparatus 200 and stored in the flash memory 204. Thus, the two-dimensional code reader 122 functions as a destination address acquisition unit in the window apparatus 10.

The two-dimensional code reader 122 may have only an imaging function. In that case, the window control apparatus 200 can execute a two-dimensional code decoding program and acquire information such as the destination address from a captured image. Additionally, although the acquisition of information in this step may involve acquiring information contained in the two-dimensional code, the information may be acquired by transmitting a reception number included in the two-dimensional code to the delivery company server 30 and requesting information corresponding to the reception number. Thus, the window control apparatus 200 and the two-dimensional code reader 122 function as destination address acquisition units for the window apparatus 10.

The processes in step S102 and step S103 are similar to the above-mentioned processes in FIG. 14. Thus, explanations thereof will be omitted. The reception processing unit 102 in the window control apparatus 200 determines whether or not the weight of the package 20 that has been acquired is within a prescribed range (step S123). If the weight is within the prescribed range (YES in step S123), then the reception processing unit 102 shifts the process to step S104. If the weight is not within the prescribed range (NO in step S123), then the reception processing unit 102 shifts the process to step S125.

In the present process, the “prescribed range” regarding the weight may be a case in which the weight pre-registered by the delivery requester and the weight acquired by the weight measurement apparatus 210 are within a range such that they can be considered to be substantially equal. For example, the “prescribed range” may be within approximately the range of measurement error with respect to the pre-registered weight. Alternatively, the “prescribed range” may be a range such that the delivery fee will not change or a range such that the delivery fee will not increase with respect to the delivery fee computed on the basis of the pre-registered weight. The process for acquiring the destination address in step S104 is similar to the above-mentioned process in FIG. 14. Thus, an explanation thereof will be omitted.

The reception processing unit 102 determines whether or not the destination address of the package 20 that has been acquired is appropriate (step S124). If the destination address is appropriate (YES in step S124), then the reception processing unit 102 shifts the process to step S105 in FIG. 21. If the destination address is not appropriate (NO in step S124), then the reception processing unit 102 shifts the process to step S125.

The case in which the destination address is “appropriate” in the present process may be a case in which the destination address pre-registered by the delivery requester and the destination address acquired by the character recognition apparatus 240 are the same. Conversely, the case in which the destination address is not “appropriate” in the present process may be a case in which the prescribed destination address pre-registered by the delivery requester and the destination address acquired by the character recognition apparatus 240 are different, or the case in which the destination address could not be read by the character recognition apparatus 240.

The reception processing unit 102 displays, on the touch panel 120 or the main display 130, a message warning the delivery requester that the weight is outside the prescribed range or that the destination address is not appropriate (step S125). This message may, for example, be a message such as: “The package cannot be accepted because the weight of the package is different from the pre-registered weight”; “The package cannot be accepted because the destination address of the package is different from the destination address that was pre-registered”; or “The destination address of the package cannot be read”. This warning may be provided as speech in the case in which the window apparatus 10 is provided with a speaker.

The reception processing unit 102 controls the shutter 150 to perform a process for opening the shutter 150 (step S126). As a result thereof, the package 20 can be taken out of the window apparatus 10 and is returned to the delivery requester. Thus, the reception processing unit 102 of the window control apparatus 200 controls the conveyance apparatus 250 so as not to start conveying the package 20 in the case in which the weight lies outside the prescribed range or in the case in which the destination address is not appropriate.

The processes in step S105 and step S106 are similar to the above-mentioned processes in FIG. 14. Thus, explanations thereof will be omitted. The reception processing unit 102 determines whether or not the dimensions of the package 20 that have been acquired are within a prescribed range (step S127). If the dimensions are within the prescribed range (YES in step S127), then the reception processing unit 102 shifts the process to step S109. If the dimensions are not within the prescribed range (NO in step S127), then the reception processing unit 102 shifts the process to step S128.

In the present process, the “prescribed range” regarding the dimensions may be a case in which the dimensions pre-registered by the delivery requester and the dimensions acquired by the dimensional measurement apparatus 220 are within a range such that they can be considered to be substantially equal. For example, the “prescribed range” may be within approximately the range of measurement error with respect to the pre-registered dimensions. Alternatively, the “prescribed range” may be a range such that the delivery fee will not change or a range such that the delivery fee will not increase with respect to the delivery fee computed on the basis of the pre-registered dimensions. Additionally, when comparing the pre-registered dimensions with the dimensions acquired by the dimensional measurement apparatus 220, the comparison may be made between each of the width, length, and height dimensions, or the comparison may be made on the sum of the width, length, and height in order to simplify the process.

The conveyance apparatus 250 reverses the direction of conveyance based on control by the reception processing unit 102, so that the package 20 is conveyed in the opposite direction (the negative y-axis direction). As a result thereof, the conveyance apparatus 250 returns the package 20 to a position near the receiving unit 110 (step S128).

Furthermore, the reception processing unit 102 controls the shutter 150 to open the shutter 150 (step S129). As a result thereof, the package 20 can be taken out of the window apparatus 10 and is returned to the delivery requester.

The processes in step S109, step S110, and step S111 are similar to the above-mentioned processes in FIG. 14. Thus, explanations thereof will be omitted. The reception processing unit 102 outputs, to the storeroom control apparatus 300, which is a transmission destination apparatus, a stow request including delivery management information (step S112). The storeroom control apparatus 300 uses the belt conveyor 23 to convey the package 20 to the stowing apparatus 22 in the storeroom 2.

In the above-described process, the window control apparatus 200 determines whether or not the weight, dimensions, and destination address that have been acquired are appropriate by comparing them with pre-registered information, and determines whether or not the package 20 can be received in accordance with the comparison results. In other words, the window control apparatus 200 functions as a determination unit for performing these determinations. Furthermore, in the case in which the weight or dimensions lie outside the prescribed range, or in the case in which the destination address is not appropriate, the driving of the conveyance apparatus 250 is controlled so as to deny acceptance of the package 20.

The window apparatus 10 in the present embodiment can receive the package 20 carried in by the delivery requester and automatically acquire the weight, the destination address, and the dimensions of the package 20 required for verifying the information regarding the package 20 that has been pre-registered and the like. Therefore, according to the present embodiment, a window apparatus 10 that can automatically acquire information required for automatically receiving packages is provided.

Additionally, the window apparatus 10 in the present embodiment is provided with a conveyance apparatus 250. The window apparatus 10 receives the package 20 carried in by the delivery requester, automatically acquires information such as the weight and the dimensions of the package 20, and controls the driving of the conveyance apparatus 250 based on this information. As a result thereof, packages 20 with inappropriate weights, dimensions or the like can be kept from being conveyed. Therefore, according to the present embodiment, a window apparatus 10 that can appropriately perform automatic reception of packages is provided.

In the above-described step S121 and step S122, the required delivery management information is acquired by reading a two-dimensional code. However, a method other than reading a two-dimensional code may be used as long as similar information can be acquired. For example, the delivery requester may be prompted to input identification information, such as the user ID or the reception number, to the touch panel 120. In response thereto, the window apparatus 10 transmits a delivery management information transmission request to the delivery company server 30, and as a result thereof, the window apparatus 10 may receive the delivery management information from the delivery company server 30. Additionally, identification information such as the user ID and the reception number may be associated with biometric information, such as a facial image of the delivery requester, in advance. As a result thereof, the window apparatus 10 can use biometric authentication such as facial authentication to identify the delivery requester and to acquire information from the delivery company server 30.

Although an example in which a two-dimensional code is used was explained for the present embodiment, a one-dimensional code may be used rather than a two-dimensional code as long as the required amount of information can be secured. One-dimensional codes and two-dimensional codes are also more commonly referred to as codes.

In the above-described process, the reception processing unit 102 may output, to the delivery requester, information for designating a delivery company from among multiple delivery companies, and as a result thereof, control may be implemented so that the delivery company designated by the delivery requester delivers the package. In this case, for example, after the above-described step S106, the reception processing unit 102 computes delivery fees for the cases in which each of the multiple different delivery companies deliver the package in the process in step S107. Additionally, the reception processing unit 102 computes estimated delivery times to the delivery destination for each of the delivery companies. For example, the estimated delivery time is information from the delivery source (the location at which the window apparatus 10 is installed) to the delivery destination. The reception processing unit 102 transmits delivery source and delivery destination information to multiple delivery company servers 30 operated by the respective delivery companies.

The respective delivery company servers 30 compute the estimated delivery times from the delivery source to the delivery destination. The delivery company servers 30 may compute computational models of the estimated delivery times by means of machine learning based on the correspondence between past estimated delivery times between delivery sources and delivery destinations, and may use the computational model to compute the estimated delivery time. Furthermore, the respective delivery company servers 30 transmit the estimated delivery times to the window apparatus 10.

The reception processing unit 102 in the window apparatus 10 receives the estimated delivery times from the multiple delivery company servers 30. The reception processing unit 102 outputs service content information including the delivery fees and the estimated delivery times to the touch panel 120 or the main display 130. The delivery requester selects a delivery company based on the service content information displayed on the touch panel 120 or the main display 130. For example, the company names of the multiple delivery companies are displayed on the touch panel 120, and a preferred delivery company is touched among the company names. Then, the reception processing unit 102 performs the subsequent reception process using the delivery fee computed for the selected delivery company in step S107. When a delivery company has been designated, the reception processing unit 102 stores identification information for the delivery company in the delivery management information.

According to this process, the reception processing unit 102 outputs information indicating different service content for each delivery company based on information on the package to be received. The reception processing unit 102 generates delivery management information including the designated delivery company input by the delivery requester as a result of outputting information indicating the service content thereof, and information regarding delivery of the package. Furthermore, the reception processing unit 102 performs a process of an automatic reception function based on the delivery management information.

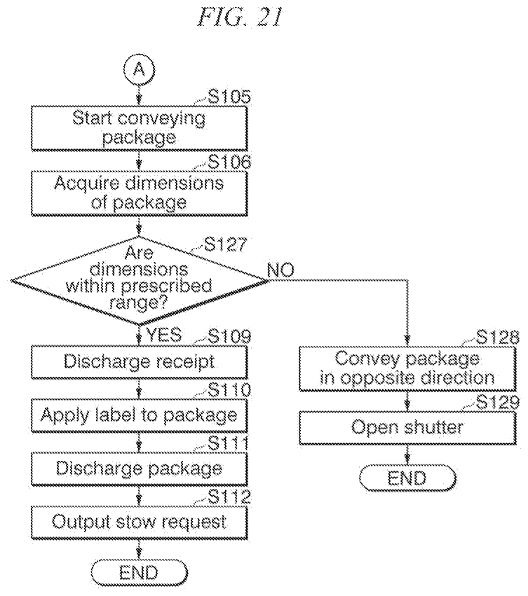

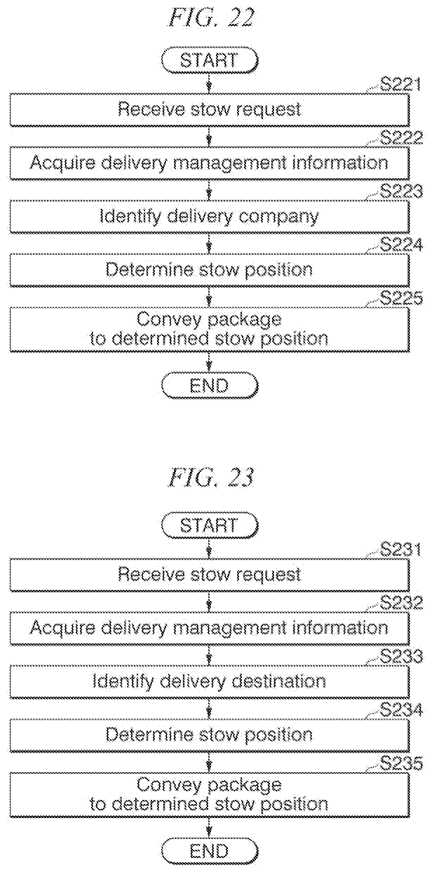

FIG. 22 is a first diagram illustrating a processing flow of the storeroom control apparatus according to the present embodiment.

The storeroom control unit 211 in the storeroom control apparatus 300 receives a stow request from the reception processing unit 11 in the window apparatus 10 (step S221). Then, the storeroom control unit 211 acquires the delivery management information included in the stow request (step S222). The storeroom control unit 211 outputs the delivery management information to the stow management unit 212. The stow management unit 212 identifies the delivery company included in the delivery management information (step S223).

The stow management unit 212 determines a stow position of the package 20 in the stowing apparatus 22 based on identification information for the identified delivery company (step S224). For example, a stow area is defined in the stowing apparatus 22 for each delivery company. The stow management unit 212 determines an empty stow position in the stow area corresponding to the delivery company identification information. Then, the stow management unit 212 controls the belt conveyor 23 and the stowing apparatus 22 to convey the package 20 to the determined stow position (step S225).

The process indicated in FIG. 22 is one mode of processing by which the stow management unit 212 computes a stow position that will lead to improved delivery efficiency by a delivery company on the basis of the delivery management information, and stows a package 20 that is received, corresponding to the delivery management information, at the stow position in the storeroom. The stow management unit 212 acquires service content information, including the delivery fee and the estimated delivery time for each delivery company, regarding the package 20 on the basis of the delivery management information. The stow management unit 212 determines the stow position of the package 20 in the storeroom 2 based on the delivery company selected on the basis of the service content information. That is, the stow management unit 212 acquires the stow position of the package 20 in the storeroom 2 on the basis of the delivery efficiency for each delivery company based on the delivery management information.

FIG. 23 is a second diagram illustrating a processing flow of the storeroom control apparatus according to the present embodiment.

The storeroom control unit 211 in the storeroom control apparatus 300 receives a stow request from the reception processing unit 11 in the window apparatus 10 (step S231). Then, the storeroom control unit 211 acquires the delivery management information included in the stow request (step S232). The storeroom control unit 211 outputs the delivery management information to the stow management unit 212. The stow management unit 212 identifies the delivery destination included in the delivery management information (step S223).

The stow management unit 212 determines a stow position of the package 20 in the stowing apparatus 22 based on the identified delivery destination (step S234). For example, a delivery company driver instructs that multiple packages 20 for which the delivery destinations are in the same area should be discharged from the stowing apparatus 22. In this case, the driver can discharge multiple packages 20 to be delivered to the same area and can load the packages onto the cargo bed of a delivery vehicle. In other words, there is no need for the driver to input, to the window apparatus 10, operations to discharge packages 20 having delivery destinations in the same area one at a time, leading to a shorter discharge time for the packages 20. In anticipation of such situations, the stow management unit 121 records stow areas in the stowing apparatus 22 that are preset for each delivery area. The stow management unit 212 determines an empty stow position in a stow area corresponding to the delivery destination of the package 20. Then, the stow management unit 212 controls the belt conveyor 23 and the stowing apparatus 22 to convey the package 20 to the determined stow position (step S235).

The process indicated in FIG. 23 is one mode of processing by which the stow management unit 212 computes a stow position that will lead to a shorter discharge time on the basis of the delivery management information, and stows a package that is received, corresponding to the delivery management information, at the stow position in the storeroom. The stow management unit 212 identifies the delivery destination on the basis of the delivery management information for the package 20, and acquires a stow position corresponding to the delivery area to which the delivery destination belongs. If multiple packages 20 having delivery destinations in the same delivery area are stowed in the same stow area, then a delivery company can discharge the multiple packages 20 having delivery destinations in the same delivery area together. As a result thereof, the discharge time of the packages 20 by the delivery company is made shorter. Thus, the stow management unit 212 computes the stow positions of the packages 20 in the storeroom 2 in accordance with the discharge time of the packages 20 based on the delivery management information.

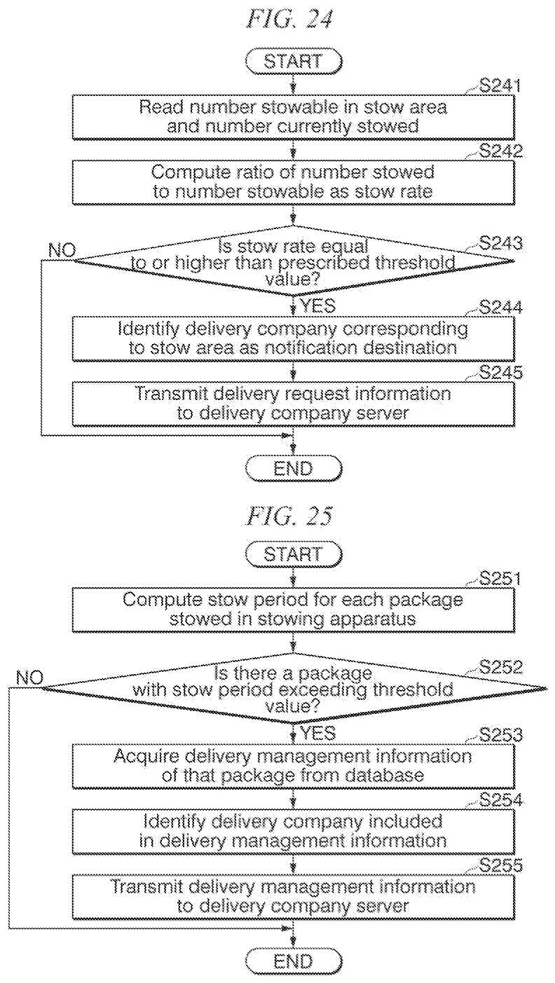

FIG. 24 is a third diagram illustrating a processing flow of the storeroom control apparatus according to the present embodiment.

The stow management unit 212 in the storeroom control apparatus 300 may, on the basis of the stowed quantity of packages 20 stowed in the storeroom 2, notify a prescribed notification destination of notification information based on the stowed quantity.

For example, the stow management unit 212 computes a stow rate of packages 20 in the stow areas defined with respect to delivery destination areas for each delivery company. For example, the stow management unit 212 reads, from a database, the number stowable in a certain stow area and the number currently stowed therein (step S241). Furthermore, the stow management unit 212 computes, as a stow rate, the ratio of the number stowed to the stowable number (step S242).

The stow management unit 212 determines whether or not the stow rate is equal to or higher than a prescribed threshold value (step S243). In the case in which the stow rate is equal to or higher than the prescribed threshold value, the stow management unit 212 identifies the delivery company corresponding to that stow area as the notification destination (step S244). The stow management unit 212 transmits, to the delivery company server 30 of the identified delivery company, delivery request information including identification information for the storeroom 2 and the stow rate (step S245). The delivery request information is information for requesting that the delivery company make a delivery.

Upon receiving the delivery request information, the delivery company server 30 outputs delivery request information to a prescribed apparatus. For example, the delivery company server 30 outputs the delivery request information to a management monitor or the like. The management monitor displays identification information for the storeroom 2 indicated by the delivery request information, and the stow rate. A person in charge at the delivery company makes arrangements to dispatch a delivery vehicle driver to the storeroom 2 identified by the identification information.

FIG. 25 is a fourth diagram illustrating a processing flow of the storeroom control apparatus according to the present embodiment.

The stow management unit 212 in the storeroom control apparatus 300 may, on the basis of the stow periods of packages 20 stowed in the storeroom 2, notify a prescribed notification destination of notification information based on the stowed quantity.

For example, the stow management unit 212 records, in a database, a time at which each package 20 was stowed. Furthermore, the stow management unit 212 computes a stow period, which is the difference between the current time and the stowing time, for each package 20 stowed in the stowing apparatus 22 (step S251).

The stow management unit 212 determines whether or not there are any packages for which the stow period has exceeded a threshold value (step S252). In the case in which there is a package for which the stow period has exceeded the threshold value, the stow management unit 212 acquires delivery management information for that package 20 from the database (step S253). The stow management unit 212 identifies the delivery company included in the delivery management information (step S254). The stow management unit 212 transmits, to the delivery company server 30 of the identified delivery company, delivery request information including identification information for the storeroom 2 and the delivery management information for the package 20 for which the stow period has exceeded the threshold value (step S255).

Upon receiving the delivery request information, the delivery company server 30 outputs delivery request information to a prescribed apparatus. For example, the delivery company server 30 outputs the delivery request information to a management monitor or the like. The management monitor displays the delivery management information and identification information for the storeroom 2 indicated by the delivery request information. A person in charge at the delivery company makes arrangements to dispatch a delivery vehicle driver to the storeroom 2 identified by the identification information.

FIG. 26 is a fifth diagram illustrating a processing flow of the storeroom control apparatus according to the present embodiment.

The stow management unit 212 may determine that the automatic reception process should be suspended based on the stowed quantity of the packages 20 stowed in the storeroom 2.

For example, the stow management unit 212 reads, from a database, the number stowable in the stowing apparatus 22 and the number currently stowed therein (step S261). Furthermore, the stow management unit 212 computes, as a stow rate, the ratio of the number stowed to the stowable number (step S262). The stow management unit 212 determines whether or not the stow rate is equal to or higher than a prescribed threshold value (step S263). In the case in which the stow rate is equal to or higher than the prescribed threshold value, the stow management unit 212 transmits, to the window apparatus 10, information indicating that reception should be suspended (step S264). Upon receiving the information indicating that reception should be suspended, the reception processing unit 102 in the window apparatus 10 suspends the reception process.

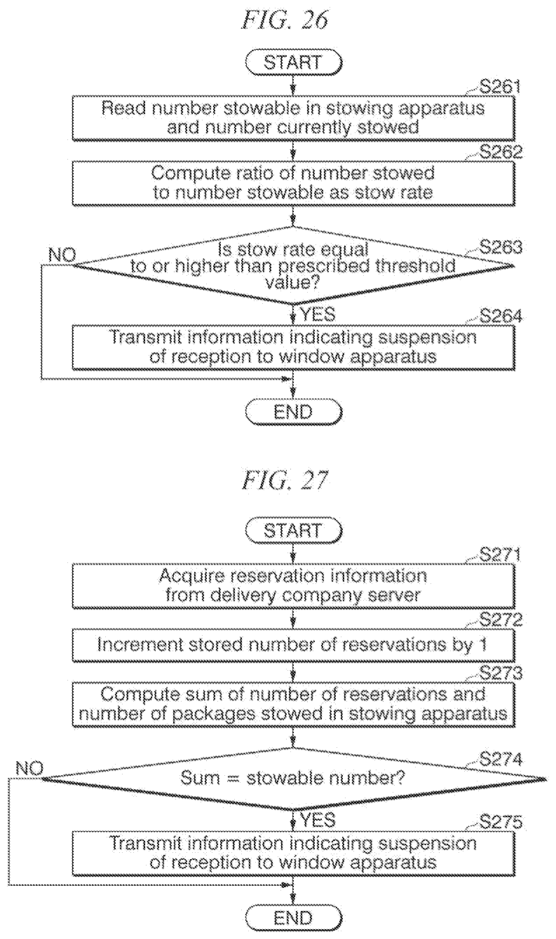

FIG. 27 is a sixth diagram illustrating a processing flow of the storeroom control apparatus according to the present embodiment.

The stow management unit 212 may determine that the automatic reception process should be suspended based on the sum of the number of packages to be received as indicated by reservation information received from a delivery company server 30, and the number of packages stowed in the storeroom 2.

For example, the delivery company server 30 accepts the designation of a storeroom 2 when receiving pre-registration based on communicative connection with the terminal 40 of the delivery requester. Then, based on the completion of the pre-registration, the delivery company server 30 transmits the reservation information to the storeroom control apparatus 300 provided in the designated storeroom 2. The reservation information may include the delivery management information.

The stow management unit 212 acquires the reservation information from the delivery company server 30 (step S271). Based on the delivery management information, the stow management unit 212 increments the number of reservations stored therein by one (step S272). If a reception process for a package 20 associated with the delivery management information indicated by the reservation information has been performed, then the stow management unit 212 decrements the number of reservations by one.

Furthermore, the stow management unit 212 computes the sum of the number of reservations and the number of packages 20 currently stowed in the stowing apparatus 22 (step S273). The stow management unit 212 determines whether or not the sum of the number of reservations and the number of packages 20 currently stowed in the stowing apparatus 22 has become equal to the stowable number (step S274). In other words, the stow management unit 212 determines whether or not the sum of the reserved packages 20 and the packages 20 being stowed has reached the stowable number. If the sum of the number of reservations and the number of packages 20 currently being stowed in the stowing apparatus 22 has reached the number stowable in the stowing apparatus 22, then the stow management unit 212 transmits, to the window apparatus 10, information indicating that reception should be suspended (step S275). Upon receiving the information indicating that reception should be suspended, the reception processing unit 102 in the window apparatus 10 suspends the reception process.

If it is determined that reception should be suspended based on the stowed quantity of the packages stowed in the storeroom, the stow management unit 212 may output information regarding other package reception locations to the window apparatus 10. The window apparatus 10 outputs the information regarding other package reception locations to the touch panel 120 or the main display 130. As a result thereof, the delivery requester confirms that the stowable number of packages 20 are stowed in the stowing apparatus 22, and moves to a storeroom 2 at another package reception location.

In the case in which reception is suspended or the like, the stow management unit 212 queries the delivery company server 30 regarding information on storerooms 2 of other package reception locations that can receive packages. The delivery company server 30 transmits the package reception location information to the storeroom control apparatus 300. The information regarding the package reception locations may include map information, contact information or the like regarding the storerooms 2 that can be the reception locations.

FIG. 28 is a seventh diagram illustrating a processing flow of the storeroom control apparatus according to the present embodiment.

The stow management unit 212 in the storeroom control apparatus 300 acquires delivery management information, identifies one or more of the packages to be discharged based on the delivery management information, and sequentially discharges the packages from the stow positions to the window apparatus 10 that is the discharge location.

The discharge processing unit 103 in the window control apparatus 200 in the window apparatus 10 detects the start of a discharge process. For example, when a delivery company driver touches a discharge process start button displayed on the touch panel 120, the discharge processing unit 103 detects the start of a discharge process.

The driver displays a two-dimensional code of delivery management information on the terminal 40. The delivery management information presented by the driver further includes, for example, identification information for the delivery company with which the driver is affiliated. The delivery management information presented by the driver may be information distributed by the delivery company server 30 to the terminal 40 carried by the driver. The delivery management information may include information regarding the delivery destination area to which the driver is to deliver the package.

The driver shows the screen of the terminal 40 to the two-dimensional code reader 122. The two-dimensional code reader 122, based on control by the discharge processing unit 103, performs a process for reading the two-dimensional code displayed on the terminal 40 carried by the driver. Before this process, the discharge processing unit 103 may implement control to display, on the touch panel 120 or the main display 130, a message prompting the driver to show the two-dimensional code to the two-dimensional code reader 122. This message may, for example, be a message such as: “Please display the two-dimensional code on your smartphone and show it to the reading unit”.

The two-dimensional code reader 122 acquires, from the two-dimensional code that has been acquired, delivery management information including a destination address or the like. The acquired delivery management information is transmitted to the discharge processing unit 103. The two-dimensional code reader 122 may have only an imaging function. In that case, the window control apparatus 200 can execute a two-dimensional code decoding program and acquire the delivery management information from a captured image. Additionally, the discharge processing unit 103 may transmit a delivery company number included in the two-dimensional code to a delivery company server 30 and acquire the delivery management information by requesting delivery management information corresponding to the delivery company number.

The discharge processing unit 103 transmits the delivery management information to the storeroom control apparatus 300. The storeroom control apparatus 300 receives the delivery management information (step S281). The stow management unit 212 in the storeroom control apparatus 300 acquires the delivery company identification information, information regarding the delivery destination area to which the driver is to deliver the package, or the like included in the delivery management information (step S282). The stow management unit 212 identifies a stow area in the stowing apparatus 22 recorded in the database in association with the delivery company identification information or the delivery destination area information (step S283). The stow management unit 212 reads, from the database, the stow position of the package 20 stowed in the identified stow area (step S284). The stow management unit 212 controls the stowing apparatus 22 and the belt conveyor 23 to discharge, to the window apparatus 10, the package 20 stowed at the stow position that has been read out (step S285).

In the window apparatus 10, the discharge processing unit 103 in the window control apparatus 200 controls the conveyance apparatus 250 to convey the package out. Based on the control by the discharge processing unit 103, the conveyance apparatus 250 reverses the conveyance direction so that the package 20 is conveyed in the opposite direction (negative y-axis direction), thereby conveying the package 20 to a position near the receiving unit 110.

Furthermore, the package is discharged from the window apparatus 10 by means of a convey-out process in the stow management unit 212 of the storeroom control apparatus 300 and a discharge process by the discharge processing unit 103 in the window control apparatus 200. The driver loads the discharged package onto the cargo bed of a delivery vehicle. Then, the driver delivers the package to the delivery destination.

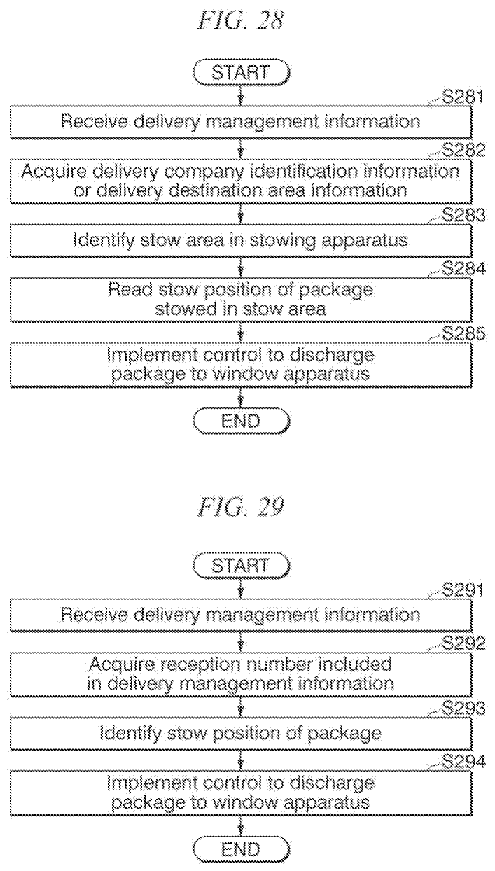

FIG. 29 is an eighth diagram illustrating a processing flow of the storeroom control apparatus according to the present embodiment.

The stow management unit 212 in the storeroom control apparatus 300 may identify a package to be discharged based on a request from an individual at a delivery destination, and discharge the package from the stow position to the window apparatus 10 that is the discharge location. For example, a storeroom 2 located in the delivery destination area may be designated as the delivery destination of the package 20. In this case, the package 20 is delivered to the storeroom 2 at the delivery destination and stowed in the stowing apparatus 22. The stowing of the package 20 in the stowing apparatus 22 is similar to that in the reception process. Then, based on an operation by the recipient for whom the delivery is intended, the discharge processing unit 103 in the window control apparatus 200 in the window apparatus 10 detects the start of a discharge process.

For example, when the recipient touches a discharge process start button displayed on the touch panel 120, the discharge processing unit 103 detects the start of a discharge process. The recipient displays a two-dimensional code of delivery management information on the terminal 40. This delivery management information is transmitted, for example, from the delivery company server 30 to a mail address of the recipient. The delivery management information may include a reception number issued during the package reception process or the like.

The recipient shows the screen of the terminal 40 to the two-dimensional code reader 122. The two-dimensional code reader 122, based on control by the discharge processing unit 103, performs a process for reading the two-dimensional code displayed on the terminal 40 carried by the recipient. Before this process, the discharge processing unit 103 may implement control to display, on the touch panel 120 or the main display 130, a message prompting the recipient to show the two-dimensional code to the two-dimensional code reader 122. This message may, for example, be a message such as: “Please display the two-dimensional code on your smartphone and show it to the reading unit”.

The two-dimensional code reader 122 acquires, from the two-dimensional code that has been acquired, delivery management information including a destination address or the like. The acquired delivery management information is transmitted to the discharge processing unit 103. The two-dimensional code reader 122 may have only an imaging function. In that case, the window control apparatus 200 can execute a two-dimensional code decoding program and acquire the delivery management information from a captured image. Additionally, the discharge processing unit 103 may transmit a reception number included in the two-dimensional code to a delivery company server 30 and acquire the delivery management information by requesting delivery management information corresponding to the reception number.

The discharge processing unit 103 transmits the delivery management information to the storeroom control apparatus 300. The storeroom control apparatus 300 receives the delivery management information (step S291). The stow management unit 212 in the storeroom control apparatus 300 acquires the reception number included in the delivery management information (step S292). The stow management unit 212 identifies a stow position in the stowing apparatus 22 recorded in the database in association with the reception number (step S293). The stow management unit 212 controls the stowing apparatus 22 and the belt conveyor 23 to discharge, to the window apparatus 10, the package 20 stowed at the stow position that has been read out (step S294).

In the window apparatus 10, the discharge processing unit 103 in the window control apparatus 200 controls the conveyance apparatus 250 to convey the package out. Based on the control by the discharge processing unit 103, the conveyance apparatus 250 reverses the conveyance direction so that the package 20 is conveyed in the opposite direction (negative y-axis direction), thereby conveying the package 20 to a position near the receiving unit 110.

Furthermore, the package is discharged from the window apparatus 10 by means of a convey-out process in the stow management unit 212 of the storeroom control apparatus 300 and a discharge process by the discharge processing unit 103 in the window control apparatus 200. Based on the reception number, the discharged package is received.

According to the above processes, the package management system 1 is provided with a storeroom 2 for stowing multiple packages 20. Furthermore, the window apparatus 10 provided in the package management system 1 may be provided with an automatic reception function for automatically receiving a package 20 to be received and stowing the package 20 in the storeroom 2, and an automatic discharge function for automatically discharging a package 20 to be discharged from the storeroom 2.

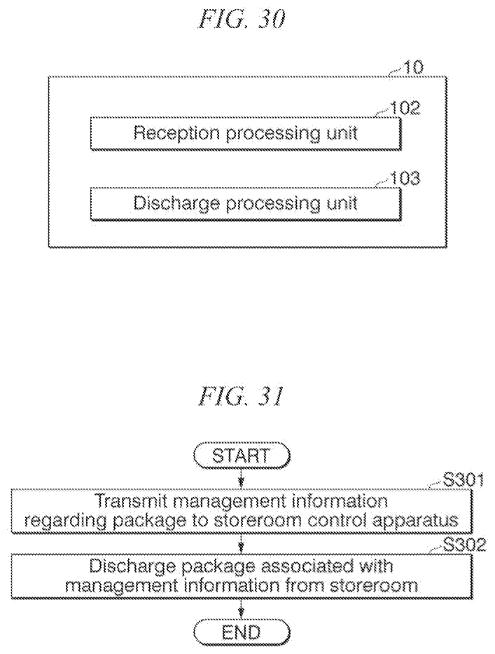

FIG. 30 is a diagram illustrating the minimum structure of the window apparatus according to the present embodiment.

FIG. 31 is a diagram illustrating the processing flow in the minimum-structure window apparatus according to the present embodiment.

The window apparatus 10 is provided with at least a reception processing unit 102 that performs processes for an automatic reception function and a discharge processing unit 103 that performs processes for an automatic discharge function.

The reception processing unit 102 transmits delivery management information regarding a package 20 to a storeroom control apparatus 300 that is a transmission destination (step S301).

The discharge processing unit 103 acquires the delivery management information and discharges a package 20 associated with the delivery management information from the storeroom 2 (step S302).

The apparatuses mentioned above have internal computer systems. Furthermore, the steps in the processes mentioned above are stored, in the form of a program, in a computer-readable storage medium, and the processes mentioned above are performed by a computer reading out and executing this program. In this case, the computer-readable recording medium refers to a magnetic disk, a magneto-optic disk, a CD-ROM, a DVD-ROM, a semiconductor memory, or the like. Additionally, this computer program may be transmitted to a computer by means of a communication line, and the computer that has received this transmission may execute the program.

Additionally, the program mentioned above may be for realizing just some of the aforementioned functions. Furthermore, it may be a so-called difference file (difference program) that can realize the aforementioned functions by being combined with a program already recorded in a computer system.

Some or all of the embodiments described above may, without being limited thereto, be as described as indicated in the supplementary notes below.

### (Supplementary Note 1)

A package management system provided with:

a storeroom for stowing multiple packages; and

a window apparatus provided with an automatic reception function for automatically receiving one or more packages to be received and stowing the one or more packages in the storeroom, and an automatic discharge function for automatically discharging, from the storeroom, the one or more packages to be discharged.

### (Supplementary Note 2)

A package management system according to supplementary note 1, wherein:

the window apparatus is provided with a reception processing unit for performing processes for the automatic reception function and a discharge processing unit for performing processes for the automatic discharge function;

the reception processing unit transmits management information regarding the one or more packages to a transmission destination apparatus; and

the discharge processing unit acquires the management information and discharges a package associated with the management information from the storeroom.

### (Supplementary Note 3)

A package management system according to supplementary note 2, wherein:

the reception processing unit outputs information indicating different service content for each of delivery companies based on information regarding the one or more packages to be received, generates the management information including information relating to delivery of the one or more packages and a designated delivery company input by a delivery requester as a result of the output of the information indicating the service content thereof, and performs a process for the automatic reception function based on the management information.

### (Supplementary Note 4)

The package management system according to supplementary note 2 or supplementary note 3,

further comprising the storeroom control apparatus,

wherein a stow management unit of the storeroom control apparatus is configured to:

compute stow positions that lead to increased delivery efficiency of a delivery company based on the management information, and stow, at the stow positions in the storeroom, the one or more packages to be received corresponding to the management information.

### (Supplementary Note 5)

The package management system according to supplementary note 2 or supplementary note 3,

further comprising the storeroom control apparatus,

wherein a stow management unit of the storeroom control apparatus is configured to:

compute stow positions that lead to shorter discharge times based on the management information, and stow, at the stow positions in the storeroom, the one or more packages to be received corresponding to the management information.

### (Supplementary Note 6)

The package management system according to supplementary note 4 or supplementary note 5, wherein

the stow management unit, based on a stowed quantity of packages stowed in the storeroom, notifies a prescribed notification destination of notification information based on the stowed quantity.

### (Supplementary Note 7)

The package management system according to supplementary note 6, wherein

the stow management unit, based on a stow period of packages stowed in the storeroom, notifies a prescribed notification destination of notification information based on the stow period.

### (Supplementary Note 8)

The package management system according to any one of supplementary note 5 to supplementary note 7, wherein

the stow management unit determines whether to suspend the automatic reception function based on the stowed quantity of packages stowed in the storeroom.

### (Supplementary Note 9)

The package management system according to supplementary note 8, wherein

the stow management unit determines whether to suspend the automatic reception function based on a sum of a number of packages to be received indicated by reservation information acquired from another apparatus and a number of the packages stowed in the storeroom.

### (Supplementary Note 10)

The package management system according to any one of supplementary note 5 to supplementary note 9, wherein

the stow management unit outputs information regarding another package reception location based on the stowed quantity of packages stowed in the storeroom.

### (Supplementary Note 11)

The package management system according to any one of supplementary note 4 to supplementary note 10, wherein

the stow management unit identifies the one or more packages to be discharged, and discharges the one or more packages from stow positions to the window apparatus that is to be a discharge location.

### (Supplementary Note 12)

The package management system according to any one of supplementary note 4 to supplementary note 11, wherein

the stow management unit acquires delivery management information, identifies one or more packages to be discharged, identified based on the delivery management information, and sequentially discharges the one or more packages from the stow positions to the window apparatus that is to be a discharge location.

### (Supplementary Note 13)

A package management method in a package management system provided with a storeroom for stowing multiple packages, the package management method comprising:

automatically receiving one or more packages to be received and stowing the one or more packages in the storeroom; and

automatically discharging, from the storeroom, one or more packages to be discharged.

### (Supplementary Note 14)

A program for making a computer in a window apparatus of a package management system provided with a storeroom for stowing multiple packages perform an automatic reception function for automatically receiving one or more packages to be received and stowing the one or more packages in the storeroom, and an automatic discharge function for automatically discharging, from the storeroom, one or more packages to be discharged.

The present application claims the benefit of priority based on Japanese Patent Application No. 2019-105320, filed Jun. 5, 2019, the entire disclosure of which is incorporated herein by reference.

### INDUSTRIAL APPLICABILITY

According to the present invention, in businesses in which there is package receiving work for packages, the labor required for the package receiving work can be reduced.

### REFERENCE SIGNS LIST

1 Package management system
2 Storeroom
10 Window apparatus
20 Package
30 Delivery company server
40 Terminal
101 Window control unit
102 Reception processing unit
103 Discharge processing unit
110 Receiving unit
111 Placement unit
112 Guide
120 Touch panel
122 Two-dimensional code reader
124 Card reader
126 Receipt discharge unit
130 Main display
140 Intercom
150 Shutter
160 Label application apparatus
170 Discharge unit
180 Support unit
190 Human sensor
200 Window control apparatus
211 Storeroom control unit
212 Stow management unit
210 Weight measurement apparatus
220 Dimensional measurement apparatus
221 First light projector
222 First light receiver
223 Second light projector
224 Second light receiver
225 Dimensional computation unit
226 Light-emitting element
230 Imaging apparatus
240 Character recognition apparatus
250 Conveyance apparatus
260 Communication apparatus
300 Storeroom control apparatus

What is claimed is:

1. A package management system comprising:
a storeroom for stowing multiple packages; and
a window apparatus comprising receiving means for receiving one or more packages to be received and stowing the one or more packages in the storeroom, and discharging means for discharging, from the storeroom, one or more packages to be discharged.

2. A package management system according to claim 1, wherein:
the receiving means transmits, to a storeroom control apparatus, a stow request including management information regarding the one or more packages; and
the discharging means acquires the management information and discharges, from the storeroom, the one or more packages associated with the management information.

3. A package management system according to claim 2, wherein:
the receiving means outputs information indicating different service content for each of delivery companies based on information regarding the one or more packages to be received, generates the management information including information relating to delivery of the one or more packages and a designated delivery company input by a delivery requester as a result of the output of the information indicating the service content, and performs a reception process based on the management information.

4. The package management system according to claim 2,
further comprising the storeroom control apparatus,
wherein a stow management means of the storeroom control apparatus is configured to:
compute stow positions of the one or more packages in the storeroom in accordance with the service content associated with delivery of the one or more packages based on the management information, and stow, at the stow positions in the storeroom, the one or more packages to be received corresponding to the management information.

5. The package management system according to claim 2,
further comprising the storeroom control apparatus,
wherein a stow management means of the storeroom control apparatus is configured to:
compute stow positions of the one or more packages in the storeroom in accordance with discharge times of the one or more packages based on the management information, and stow, at the stow positions in the storeroom, the one or more packages to be received corresponding to the management information.

6. The package management system according to claim 5, wherein
the stow management means determines whether or not the reception process for the one or more packages is to be suspended based on a stowed quantity of packages stowed in the storeroom.

7. The package management system according to claim 4, wherein
the stow management means identifies the one or more packages to be discharged, and discharges the one or more packages from stow positions in the storeroom to the window apparatus that is to be a discharge location.

8. The package management system according to claim 4, wherein
the stow management means acquires the management information, identifies one or more packages to be discharged, identified based on the management information, and sequentially discharges the one or more packages from the stow positions to the window apparatus that is to be a discharge location.

9. A package management method in a package management system provided with a storeroom for stowing multiple packages, the package management method comprising:
receiving one or more packages to be received and stowing the one or more packages in the storeroom; and
discharging, from the storeroom, one or more packages to be discharged.

10. A non-transitory computer-readable program-storing storage medium for making a computer in a window apparatus of a package management system provided with a storeroom for stowing multiple packages perform processes of:
receiving one or more packages to be received and stowing the one or more packages in the storeroom; and
discharging, from the storeroom, one or more packages to be discharged.
